(19) United States
(12) Patent Application Publication
(10) Pub. No.: US 2023/0156111 A1
(43) Pub. Date: May 18, 2023

(54) METHODS AND APPARATUS FOR PLACING CALL USING QR CODE

(71) Applicant: PETER MANH PHAM, San Jose, CA (US)

(72) Inventor: PETER MANH PHAM, San Jose, CA (US)

(73) Assignee: SQUAREPING INC., San Jose, CA (US)

(21) Appl. No.: 17/878,007

(22) Filed: Jul. 31, 2022

Related U.S. Application Data
(60) Provisional application No. 63/295,891, filed on Jan. 2, 2022.
(60) Provisional application No. 63/300,188, filed on Jan. 17, 2022.
(60) Provisional application No. 63/280,800, filed on Nov. 18, 2021.
(60) Provisional application No. 63/295,891, filed on Jan. 2, 2022.
(60) Provisional application No. 63/300,188, filed on Jan. 17, 2022.
(60) Provisional application No. 63/307,014, filed on Feb. 4, 2022.
(60) Provisional application No. 63/327,372, filed on Apr. 5, 2022.

(51) Int. Cl. H04M 1/665; H04L 65/1046; H04W 8/18; H04L 65/1073; H04L 65/1069; G06K 19/06; G06K 7/14; G06K 7/10

(52) U.S. Cl. CPC H04M 1/665; H04L 65/1046; H04W 8/18; H04L 65/1073; H04L 65/1069; G06K 19/06037; G06K 7/1417; G06K 7/1095

(57) ABSTRACT

A Methods and application for mobile devices that allow users to engage in an audio and/or video call using QR code. The system comprises a call service system and a mobile app to be executed on the user's mobile device for initiating a call and receiving a call. Contact information of one or more call recipient are recorded in a ping tag. The QR code is generated from a network call-placing process identifying the said ping tag as the call destination. Using a default camera app on a mobile device, the present invention allows a caller to simply scans QR code to place a call to call recipient(s) associated with the ping tag of the present invention through the call service system.

### FIELD OF THE INVENTION

The present invention is related to mobile device application and more particularly, to a methods and application for mobile device users to make audio or video call to mobile device using a readable code such as image-based bar code, QR code, or the like with a mobile device having built-in camera.

### BACKGROUND OF INVENTION

As camera price goes down dramatically in recent years, camera doorbell device such as Amazon Ring gains popularity. Devices such as Ring, serves both as the doorbell as well as a modern mechanism for home owners to inspect the person at the front door prior to opening the door. Through the Internet, a homeowner can have access to front door view even when they are at another location, e.g., work. Furthermore, the homeowner can also remotely communicate with the visitor via a speaker and microphone on the doorbell device from own mobile device. However, a typical camera doorbell device costs around $150.00 to $200.00, not to mention the cost of installation and maintenance. While such a cost is not a concern for medium to high income earners, it could be a burden for low-income earners. Presently, there is no such mechanism for people living in a building such as an apartment, condominium, townhome, etc., or gated community. People living in such a community and building still very much rely on a traditional camera-less Intercom system to communicate with visitors. As housing and rental price sky-rockets in recent years, shared living space has also become phenomenally common place, especially in crowded cities such as San Francisco and New York. The need for individual contact in such living environment has become complicated as an individual resident sharing an apartment or home may not want to bother other residents when his visitor is knocking on the door or ring the doorbell. One way to work around this issue is for a resident to post a sticker note on the door or in the lobby, in case of a condo/apartment building, for his visitors to call his/her own mobile phone instead. Yet, the dilemma is that the resident may not want to expose own mobile phone number in public place due to privacy concern. Similarly, as robot call has now become an annoying spam and damaging scam epidemic, people have become more cautious when exposing their phone number online in any forms, such as email, classified ads, e-commerce websites, etc. That, of course, is without losing the convenience that modern technology offers.

In a related development of consumer trend, the QR code is gaining in popularity all over the world for use in many applications. QR code is a cryptic image that is linked to a text message, an image or an Internet resource link (URL). Today, since Internet is readily accessible everywhere on mobile device, mobile apps are widely available to scan and link a QR code image to a specific preset information resource, e.g., a web site, a business contact, a product information, etc., or a computing operation such as processing a payment. For example, to retrieve information about a product which is tagged with a QR code, smart phone user opens the camera app, simply aims the back camera to scan the QR code image of the product, the camera app then automatically translates the QR code image to a preset weblink (URL) and launching the web browser for accessing the information on the product on the Internet. QR code image can be generated in a variety of graphic formats such as EPS or SVG vector graphic, as well as high-resolution PNG, GIF or JPEG raster graphics format and use them where they see fit, e.g., printing the image on a sticker, business card, etc., or embedding it directly on own website for visitors to retrieve contact information without exposing contact information on the web page; thus, avoiding contact information being harvested by web crawler tool for spamming. Today, QR code image comes in a variety of mediums, e.g., on leaflets, posters, business cards, web page, or products. In China, people just have to scan a QR code to purchase and make payment for a product on the shelf or on a website. As time progresses and market acceptance skyrockets, QR code will surely find its way into various practical applications.

### SUMMARY

Accordingly, the present invention comprises methods and application for mobile device users to make contact with one another without exposing own contact phone number using a QR code comprising a mobile app executing on a plurality of mobile device and call service system coupled together on a computer network such as the Internet. The said mobile app is executed on a user's mobile device to place a voice or video call or to receive and answer calls initiated from the said call service system. The said call service system further comprises a user management system and a call server that are further coupled with a backend database system, storing a user database and a call database over a computer network such as the Internet. The user database further comprises a user profile table and a group table. The said call database contains a call session table and a ping tag table. The said user profile table contains user registration data, user authentication data, abuse reports and other operation-related data collected from the user's usage pattern and user's device. The group table is used to establish group relationship among several users, e.g., members of a family or business, residents of a living community, etc. The said call session table contains list of call sessions. Each call session further contains a caller id, one or more caller id(s), call mode, call status and other call data analytic information. The said ping tag table contains list of ping tags. Ping tag is a contact tag representing a group of one or more call recipients. It contains information identifying the call recipients and other call-related options. Each ping tag entry stores various call settings and a list of one or more call recipient. The call settings specify several options such as how an incoming call will be processed by the call service system, the type of call, e.g., audio or video, security options, PIN code, time limit, etc. The QR code aforementioned is an encoded representation of a call service offered by the call service system accessible via a web resource link (URL). The said URL comes with a ping tag identifier included. The call service system will use the ping tag identifier to identify the call recipients and call processing options stored in the ping tag itself.

### BRIEF DESCRIPTION OF THE DRAWINGS

The above and still further features and advantages of embodiments of the present invention will become apparent upon consideration of the following detailed description of embodiments thereof, especially when taken in conjunction with the accompanying drawings, and wherein:

FIG. 1 illustrates a block diagram of a smart doorbell system for placing call using QR code, according to embodiments of the present invention disclosed herein;

FIG. 2 illustrates a view depicting a call screen, according to embodiments of the present invention disclosed herein;

FIG. 3 illustrates a view depicting a call conversation screen, according to embodiments of the present invention disclosed herein;

FIG. 4 illustrates a view on screen for selecting a tag type, according to embodiments of the present invention disclosed herein;

FIG. 5 illustrates a view of a tag profile editing, according to embodiments of the present invention disclosed herein;

FIG. 6 illustrates a view of a call recipient list, according to embodiments of the present invention disclosed herein;

FIG. 7 illustrates a view of a contact list, according to embodiments of the present invention disclosed herein;

FIG. 8 illustrates a view of a tag profile display on caller's screen, according to embodiments of the present invention disclosed herein;

FIG. 9 illustrates a view of a tag image screen, according to embodiments of the present invention disclosed herein;

FIG. 10 illustrates an image of a tag listing screen, according to embodiments of the present invention disclosed herein;

FIG. 11 illustrates a process of scanning the tag, according to embodiments of the present invention disclosed herein;

FIG. 12 illustrates a display of tag profile after scanning successfully, according to embodiments of the present invention disclosed herein;

FIG. 13 illustrates a method flowchart of incoming call processing by call service module, according to embodiments of the present invention disclosed herein;

FIG. 14 illustrates a caller-side call screen while waiting for call acceptance, according to embodiments of the present invention disclosed herein;

FIG. 15 illustrates a callee-side preview screen, according to embodiments of the present invention disclosed herein;

FIG. 16 illustrates no answer call screen, according to embodiments of the present invention disclosed herein;

FIG. 17 illustrates a method for an incoming call processing by callee platform, according to embodiments of the present invention disclosed herein;

FIG. 18 illustrates a call conversation screen, according to embodiments of the present invention disclosed herein;

FIG. 19 illustrates a call history log, according to embodiments of the present invention disclosed herein;

FIG. 20 illustrates a caller screen after a tag is scanned, where the tag profile is displayed, according to embodiments of the present invention disclosed herein;

FIG. 21 illustrates a Mobile call confirmation prompt on the platform, according to embodiments of the present invention disclosed herein;

FIG. 22 illustrates a Mobile call in-progress, according to embodiments of the present invention disclosed herein;

FIG. 23 illustrates a PINGPAD service platform for placing a call using QR code, according to embodiments of the present invention disclosed herein;

FIG. 24 illustrates a PINGPAD service registration form, according to embodiments of the present invention disclosed herein;

FIG. 25 illustrates a subscription form, according to embodiments of the present invention disclosed herein;

FIG. 26 illustrates the view of a subscription, according to embodiments of the present invention disclosed herein;

FIG. 27 illustrates a method flowchart for a member tag setup, according to embodiments of the present invention disclosed herein;

FIG. 28 illustrates a method flowchart for a visitor call request handling, according to embodiments of the present invention disclosed herein;

FIG. 29 illustrates a caller screen after scanning tag, according to embodiments of the present invention disclosed herein;

FIG. 30 illustrates a pre-printed tag image, according to embodiments of the present invention disclosed herein;

FIG. 31 illustrates a process for claiming pre-printed tag, according to embodiments of the present invention disclosed herein;

FIG. 32 illustrates a screen for adding a tag to the app of the present invention, according to embodiments of the present invention disclosed herein;

FIG. 33 illustrates scanning unassigned tag for tag id, according to embodiments of the present invention disclosed herein;

FIG. 34 illustrates a tag with common QR code and distinct access code, according to embodiments of the present invention disclosed herein;

FIG. 35 illustrates a prompt for access code, according to embodiments of the present invention disclosed herein.

FIG. 36 illustrates a smart doorbell with a QR code image display, according to embodiments of the present invention disclosed herein;

FIG. 37 illustrates a block diagram for the smart doorbell system, according to embodiments of the present invention disclosed herein;

FIG. 38 illustrates a tag with QR code baggage label, according to embodiments of the present invention disclosed herein;

FIG. 39 illustrates baggage claim ticket to be issued to travel passenger. The ticket contains a QR code for downloading the app of the present invention and a tag with QR code for claiming contact point of one or more baggage tag, according to embodiments of the present invention disclosed herein;

The headings used herein are for organizational purposes only and are not meant to be used to limit the scope of the description or the claims. As used throughout this platform, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures. Optional portions of the figures may be illustrated using dashed or dotted lines, unless the context of usage indicates otherwise.

### DETAILED DESCRIPTION OF FIGURES

The following description includes the preferred best mode of one embodiment of the present invention. It will be clear from this description of the invention that the invention is not limited to these illustrated embodiments, but the invention also includes a variety of modifications and embodiments thereto. Therefore, the present description should be seen as illustrative and not limiting. While the invention is susceptible to various modifications and alternative constructions, it should be understood, that there is no intention to limit the invention to the specific form disclosed, but, on the contrary, the invention is to cover all modifications, alternative constructions, and equivalents falling within the spirit and scope of the invention as defined in the claims.

In any embodiment described herein, the open-ended terms “comprising,” “comprises,” and the like (which are synonymous with “including,” “having” and “characterized by”) may be replaced by the respective partially closed phrases “consisting essentially of,” consists essentially of,” and the like or the respective closed phrases “consisting of,” “consists of, the like.

As used herein, the singular forms “a”, “an”, and “the” designate both the singular and the plural, unless expressly stated to designate the singular only.

The present invention comprises a system and a call app, ‘the app’ for short, executing on mobile phone devices to allow users of the app to place a video call to one or more users of the app by scanning a QR code image. The app often comes in the form of an app pre-installed on a mobile device if the user is a registered user and have the app installed on own device or it could come in the form of a web browser script dynamically downloaded to a mobile device for execution in a web browser context should the user has not installed the app on own device. The app and the script are functionally equivalent in terms of call-making and call-receiving operations and therefore, commonly refers to as ‘the app’. The only difference is how they are executed which is depending on whether the app is installed on the user's device or not. The app and the system are coupled to each another over a computer network such as the Internet.

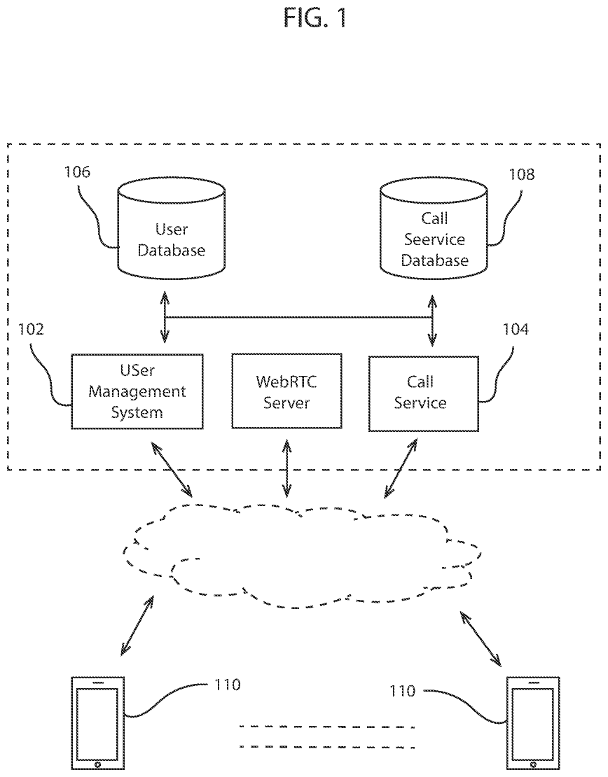

FIG. 1, illustrates a system of the present invention accessible as cloud services and a plurality of the app of the present invention, each executing on an end-user mobile device (110) with access to services over a network cloud such as the Internet.

The system comprises a user management system (102) and a call service system (104), aka. ‘Call server’ for short. The service systems are further coupled to the backend database system over a computer network that comprises a user database (106) and a call database (108). The user management system is mainly responsible for registering and authenticating users for service as well as performing administrative user management tasks requested by the system administrator. Once registered, a globally unique user identifier (ID) and associated authentication password are issued to the user in association with a unique identifier, such as the device's phone number or user's email address, for user's identification. During the registration, the user can also input some other user profile information such as name, email address, phone number, avatar image, etc. Additionally, analytic data such as black-listed counter, user's device information, e.g., manufacturer, device type, OS version, etc., are automatically collected and recorded every time the user's logon to the service system for use in determination of operation details as well as analytics. The user information is stored in a respective user profile record of the user profile table of the user database. The call service database maintains at least a call session table, a ping tag table and a black list table.

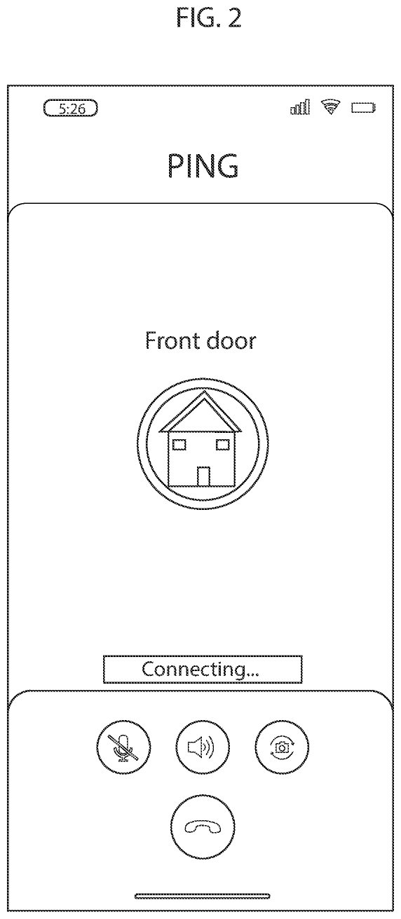

The call session table is used to keep track of past and ongoing calls. A call session record contains information relating to a call, e.g., caller id, ping tag id, call-start and call-end timestamps, call status, list of active call participants, call management and analytic data. The ping tag id is used to retrieve tag settings for processing and call recipient list for signaling. The call participant list contains a list of caller id and qualified call recipient ids. Each participant entry maintains a call status which is either ACTIVE, i.e., join call, INACTIVE, i.e., not join, or LEFT, i.e., hang up. The LEFT status differs from INACTIVE in which it indicates the associated call participant had actually participated in the call, while INACTIVE status indicates a call participant has never participated in the call. Such fine-grained status management is useful for data analytics tool at a later time. The ping tag table contains list of ping tag record entries, each of which stores a unique ping tag id, owner's user id, call status, call-related settings and a list of one or more call recipient. In its simplest form, the call settings specify some call-related options such as how an incoming call will be processed, aka. call routing mode, and the type of call, e.g., audio or video. More options will be added to the call settings in various later embodiments. The black list table stores a list of callers who are black-listed by ping tag owners from calling them using their own ping tags. Each entry in this table contains a timestamp when the black listing event occurs, the user id of the owner of a ping tag, the user id of the black-listed caller and the ping tag id. Once a caller is black-listed against a ping tag, the caller will not be able to initiate call request from the specified ping tag. Also noted that, throughout the description, screen images of SQUAREPING app will be used as examples for easy visualization of the present invention since the app is an actual commercial implementation of the app of present invention as depicted in FIG. 2.

However, they should not be construed as a limitation to the user interface process of the present invention. In fact, those skilled in the art should recognize that there are many ways a user interface can be presented to the users depending on preferences. Today, all mobile devices such as Apple iPhone and Android phone come with a default camera app that can be used to scan a QR code image and translate it to an executable web command (or invoke an app installed on the device) when the user taps on. The end-user mobile device is expected to subscribe to, at least, data network services from mobile phone carriers and, therefore, at minimum, is capable of establishing network access to cloud-based data services and digital video call over the Internet. Those skilled in the art should readily recognize that cloud service deployment is modern technology that enables a service to scale across multiple geographical areas for serving world-wide users with reasonable service response time. In addition to the usual connection to mobile phone network for phone service, the call app of the present invention is required to establish a persistent communication channel with the service system for sending and receiving messages when possible. The communication channel may be over a well-known transport protocol such as TCP or UDP or a message-based push notification service such as Google Cloud Messaging (GCM) or Apple Push Notification (APN) service, depending on the device operating system. By default, a unique push notification token is generated and automatically assigned to a device after a user starts the app on a device. This token is in effect during the lifetime of the logon session and used by the server to address push notification messages to the associated device. The token is recorded in the respective user's record of the user database on the service system and, therefore, retrievable using the user's id. Additionally, on startup, the call server also requests a server key from the push notification service for later use in sending notification messages to user devices. However, since the video calls are made using digital technology over data network, several technologies are available for providing support for such type of calls, from server-centric architecture, e.g., the well-known Jitsi video conference call server, to peer-to-peer video call technology, e.g., WebRTC protocol. Transport connections for data and video channels are necessary to provide support for both protocols. Additionally, the control channel for establishing peer-to-peer WebRTC call uses ad-hoc transport connections for relaying request and response messages, aka. call signals, between the caller, the callees and the call server. On the call server side, the handle of this transport connection, well-known as ‘socket’, is recorded in association with the user id and is retrievable by the call server for use in receiving and sending messages from or to call parties of a call session. Similarly, database structures and database operations such as CRUD, socket operations, API calls, call signaling, media stream construction and relinquishing, etc. are well-known prior arts. Those skilled in the art should be able to implement them with ease. Therefore, the implementation of such well-known prior arts will not be described in details in the description. Also, unless otherwise stated, all communications between the user's device with other users' device or with the said system will be carried out in secure manner using appropriate secure protocols in order to prevent middle-man attack, eavesdrop as well as data alteration while in transit on the network. Throughout the embodiments as described below, whenever the app or the service system receives a message from the other modules of the system, a validation step is automatically performed on the message to ensure given parameters are valid, e.g., the caller, callee(s), the opcode, etc., prior to message processing. This validation process also includes whether a caller is black-listed by the system or by a ping tag owner by querying the black-listed table. Furthermore, cache storage for information dynamically created during the processing of an operation is generally persistent memory unless otherwise stated. The contact list as mentioned in the embodiments is a list of contacts from the phone app contact list. Although, some of them may be registered users of the call service system of the present invention. In call setup over data network like that of the present invention, a call signal, e.g., call request, accept, reject, hang-up, etc., is delivered using either a corresponding REST API call or network request to the call server passing relevant data about the parties in the call and related call session id. Call signal is another form of short message over a data connection, which is used to convey the status of a call at a transmitting party to the call server which is tracking and maintaining the call status of a call session.

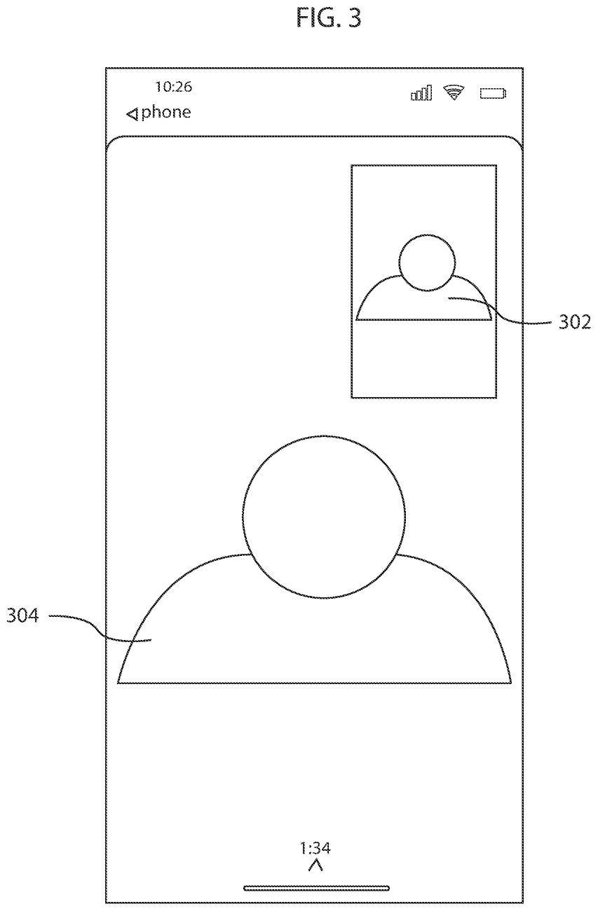

Additionally, some terms frequently used in the description of the embodiments need to be clarified here to avoid confusion, e.g., ‘mobile device’ is generally described a hand-held device capable of wireless connectivity for placing phone call and establishing data connection over the Internet, ‘caller’ refers to the user who initiates a call, ‘callee’ refers to a call recipient. ‘Call screen’, as depicted in FIG. 2, refers to a graphical user interface for placing or receiving a call and engaging in conversation between call participants and ‘Call conversation screen’ refers to a screen where video streams of caller (302) and callee (304) are displayed as depicted in FIG. 3. ‘Call signal’ in data network implies a message or an API call resulting in a data message used for communicating events between communicating devices, not an analog signal in traditional telecom network. ‘Ping tag’ refers to the QR code associated with a ping tag setup, which is a printed label, or an image of it, containing the QR code of the present invention. ‘Ping tag record’ or ‘ping tag setup’ refers to the ping tag configuration stored in the ping tag table. ‘Ping tag owner’ refers to the user or business entity who created a ping tag. ‘Ping id’ or ‘ping tag id’ refers to a unique string of characters identifying a ping tag record. ‘Ping call’ refers to a data call made using the methods of the present invention. ‘Caller app’ refers to the app executing on the user who initiates the call using the methods of the present invention, which may be a web browser instance or a SQUAREPING app instance. ‘Callee app’ refers to the app executing on call recipient's device. A network ‘API call’ can either be a socket API call or a REST API call, whichever is suitable for a particular operation. ‘Unassigned’ or ‘unclaimed’ ping tag refers to the same thing, which is a ping tag that has not yet been associated with a point of contact device.

### Ping Tag

Ping tag is a QR code image to be printed on a print material such as sticker to be posted on an object or a digital representation of the image to be shared online. The code that is used to generate the image is a well-known web URL referencing a computer process on a cloud service system such as SQUAREPING site. An example of such URL is as below:

https://ping.squareping.com/ping/<ping-tag-id>

where ‘ping.squareping.com’ is the domain name of the site providing service. ‘ping’ is the name of the service and <ping-tag-id> is a computer-generated unique identifier to identify a specific ping tag in the system. Each ping tag is recorded in SQUAREPING system using ping tag table aforementioned of which record stores the unique identifier of a ping tag and associated operational settings.
Before a user can receive a call from a caller using the method of the present invention, s/he must set up and create a ping tag. Using the app, a user sets up desired tag options and a list of one or more call recipient, which often includes the owner of the ping tag. Once a ping tag is setup and created, a corresponding QR code image can then be generated from it and posted where appropriated for others to scan and place a call to the call recipient(s) of the tag when necessary. A call recipient should be ready to receive incoming call from the call service system of the present invention using the app of the present invention.

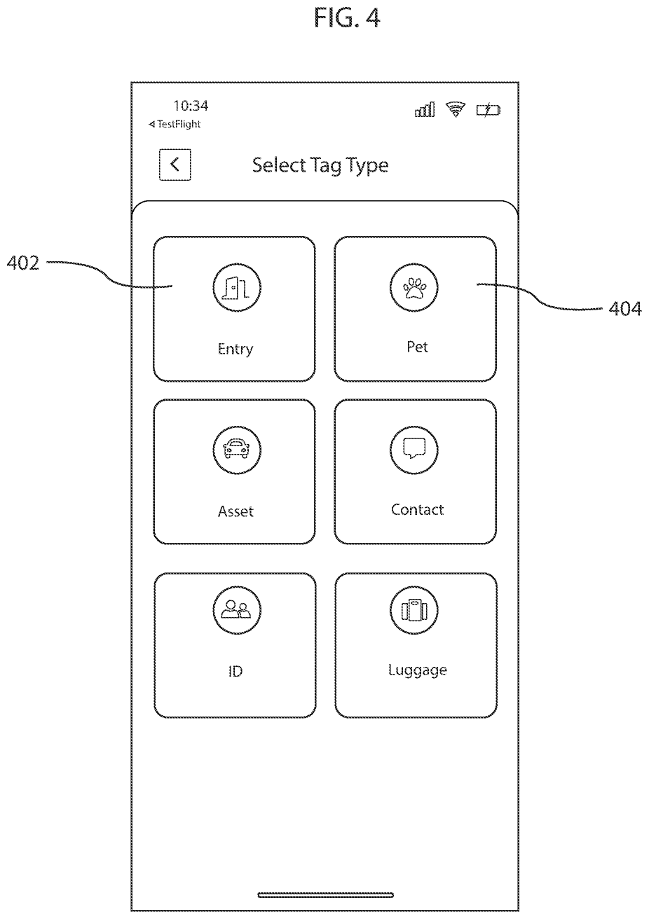

FIGS. 4 to 7 depicts a typical ping tag setup process during which the user can specify several options. First, the user selects the type of tag to be created as depicted in FIG. 4. SQUAREPING app provides support for a variety of tag types intended for various applications. Among them are:

Entry—to be printed and applied on entry door for visitors to call resident

Pet—to be printed and applied on pet tag for calling pet's owner

Asset—to be printed and applied on personal belongings and/or business assets such as laptop, phone, computer system, printer, vehicle, bike, motorcycle, scooter, etc.

Luggage—to be printed and applied on travel luggage for recovery

Package—to be printed and applied on shipping package for recovery

ID—to be printed and applied on children's, elderly's, medical patient's identification tag

Contact—to be printed and applied on print materials such as business card, product brochure, flyer, etc. or shared online such as email, website, social networks, etc. as a means for contact in place of or in addition to phone number.

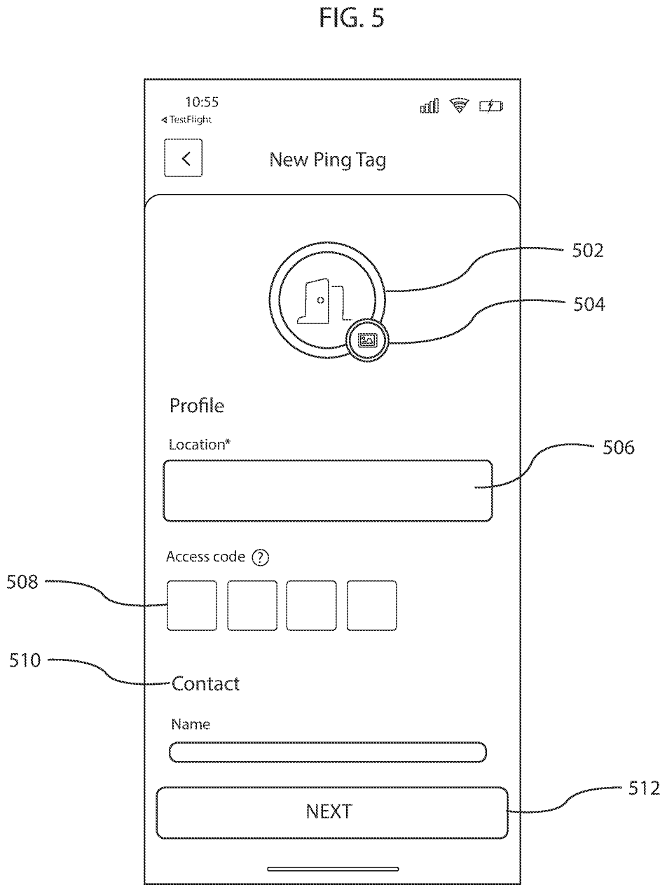

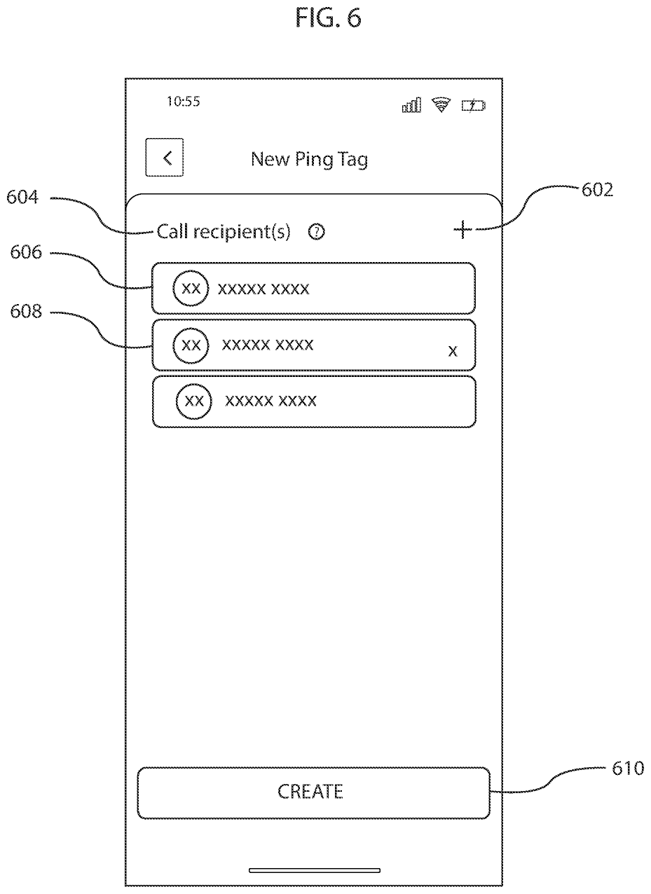

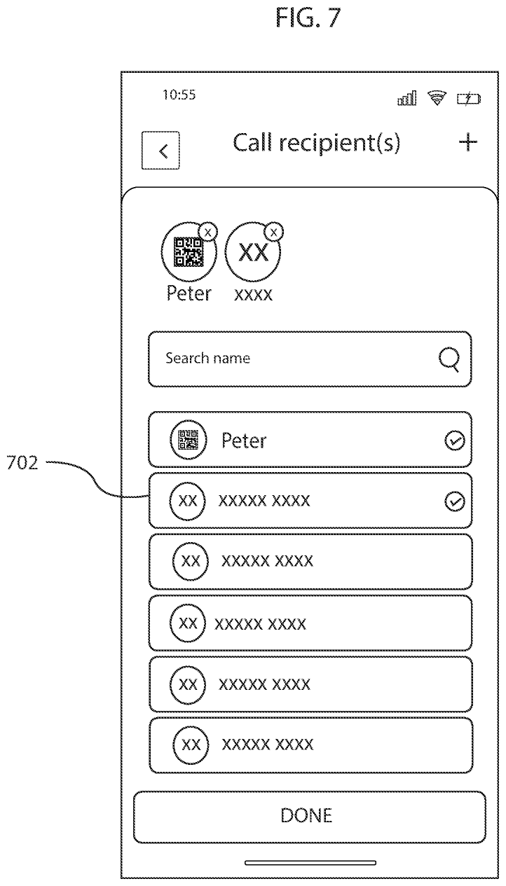

Each type of tags requires a different set of profiles. For example, refer to FIG. 4, ‘Entry’ tag type (402) applies to entry security application, of which profile includes the entry location where the tag will be posted, e.g., entry gate, front door, side door, etc., an optional access code and alternate contact information, which may include name of the person to contact and phone and/or email address, etc. A pet tag (404) profile may include the pet's name, any useful information about the pet and contact information, etc. Asset tag is used for tagging personal belongings and business assets. ID tag is for identification applied to children, elderly, medical patient, personal or business identification used in applications, etc. Contact tag is for personal or business contact. Luggage and package tags are for tagging luggage and shipping packages, respectively. Similarly, other tag types for other applications may have their own profile which vary depending on the specific application of the tag. Assuming Entry tag type is selected, the next screen, refer to FIG. 5, is displayed for the user to specify the tag profile data. For example, as mentioned earlier, the Entry profile includes information such as the entry location (506), an optional access code (506) and an optional image of the entry (502). Access code (508) is a means for avoiding call abuse. If specified, a caller will be required to input a correct access code as set in the profile in order for a call to proceed. As shown in the example, the access code is a 4-decimal digit code. A small button at the bottom right of the profile image is a button (504) that the user uses to select an image from the device's photo gallery or to take a live photo of the entry. There is also an optional contact information aforementioned (510), where the user can specify alternate contact if so desired. The NEXT button (512) leads the user to the next setting screen in the process, which is a list of call recipients as depicted in FIG. 6. By default, the user, i.e., tag owner, (606) is automatically added as a call recipient in the list (604). Other(s) (608) may be added to the call recipient list by the user. The Plus (+) icon (602) allows the user to add other users to the call recipient list by invoking a screen listing the user's phone contacts for selection as depicted in FIG. 7. If selected, the user id of the selected contact (702) will be added to the call recipient list. Thus, a typical ping tag record would contain at least the following information in well-known JSON format:

```
  {
    CreateTimestamp,
    LastUpdateTimestamp,
```

| | |
|---|---|
| TagId, | // Unique ping tag id |
| UserId, | // Tag owner - unique app user id |
| TagType, | // Entry, Pet, Asset, ID, Contact, ... |
| TagProfile { | // Optional profile information |

ProfileImage,

| | |
|---|---|
| ProfileInfo, ... | // Vary on tag type |
| Contact { | // Optional alternate contact details |
| Name, | // Alternate contact name |
| Address, | // Alternate contact address |

PhoneNumber, // Alternate contact phone number

| | |
|---|---|
| Email, | // Alternate contact email address |
| SocialNetworkIds | // REST API to access alternate |

```
contact social network profile
      }
    },
    CallRecipients {
```

| | |
|---|---|
| UserIds | // List of call recipients |

```
    }
  }
```

It is noted that users who are added to a call recipient list of a ping tag of another user will be able to view the ping tag on their app so they are aware of their participation as a call recipient of a ping tag but they cannot edit the ping tag settings. Only the ping tag owner can change a ping tag setting. The UserIds field is a shorthand notation of one or more call recipients selected from the contact list of the user's device. Refer to FIG. 7, a contact entry (702), stores the call recipient's name and the contact phone number or email address, whichever is used as user id of the system of the present invention. It is also noted that this method of call recipient selection only applies when the phone number of a device is used as user's id. If other means is used as user's id, such as email address, the phone contact list, which is based on phone number, may not apply. In such case, another mechanism must be used to add call recipient(s) to the list.

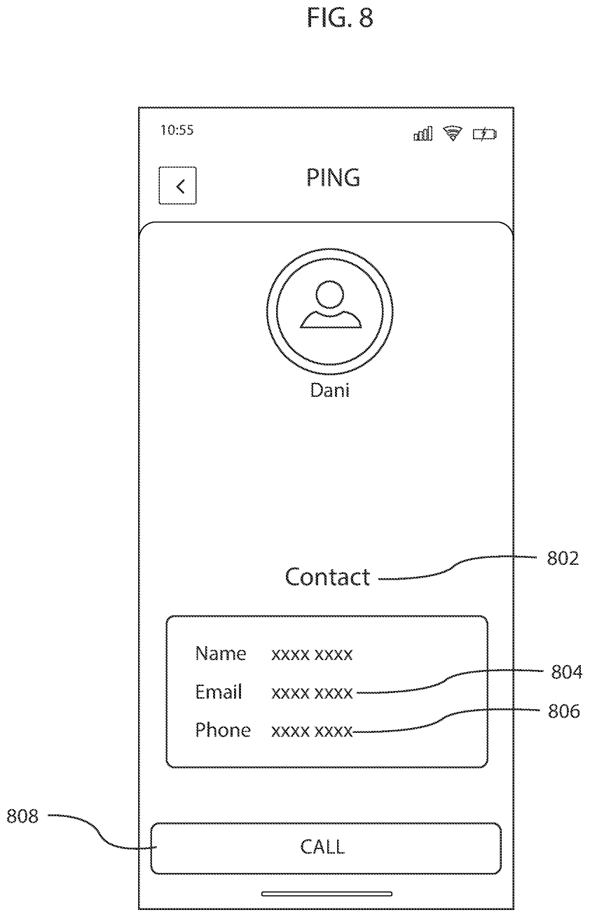

Now, refer to FIG. 8, which displays a tag profile screen of a ping tag after the caller scans the ping tag. This screen displays profile information aforementioned. The alternate contact section (802) is displayed on caller's device screen only when the user specified them during the tag setup process. When on display, the alternate contact information, i.e. phone number (806) and/or email address (804), are automatically linked to the corresponding app on the caller's mobile device, so that if a caller chooses to tap on an alternate contact, the corresponding app on the caller's mobile device is invoked for quick access. Such user interface techniques are well-known prior arts. For example, when the caller taps on the phone number, the app will automatically invoke the default phone app passing to it the phone number of the tag owner for the caller to make the call simply by tapping the call button on the phone app. Similarly, SocialNetworkIds is a list of REST APIs that the caller can use to gain access to alternate contact's profile on social networks such as Twitters, Facebook, LinkedIn, PinkInterest, Whatapp, Snapchat, etc. that the tag owner optionally specifies as alternate contact(s) during the tag setup process. The CALL button (808) is used to initiate a call to the tag owner using the method of the present invention to be described subsequently.

Back to FIG. 6, once the user finishes setting up a ping tag and taps on the CREATE button (610) to complete the setup, the app invokes a Create Ping Tag API to the call service system for creating the ping tag on the service system passing along the ping tag setup information and the user id. Upon receiving this request, the call server generates a unique ping tag id and assigns it to the newly-created ping tag and then saves the ping tag to the ping tag table of the call service database. This, in effect, associates the user id and the ping tag id with the tag setup. The id will be used for ping tag management operations. On success, the call server will return the ping tag id to the app. This id is later used for constructing a ‘ping URL’ by appending the ping tag id to a preset URL as given in the example below:

https://ping.squareping.com/ping/<ping-tag-id>

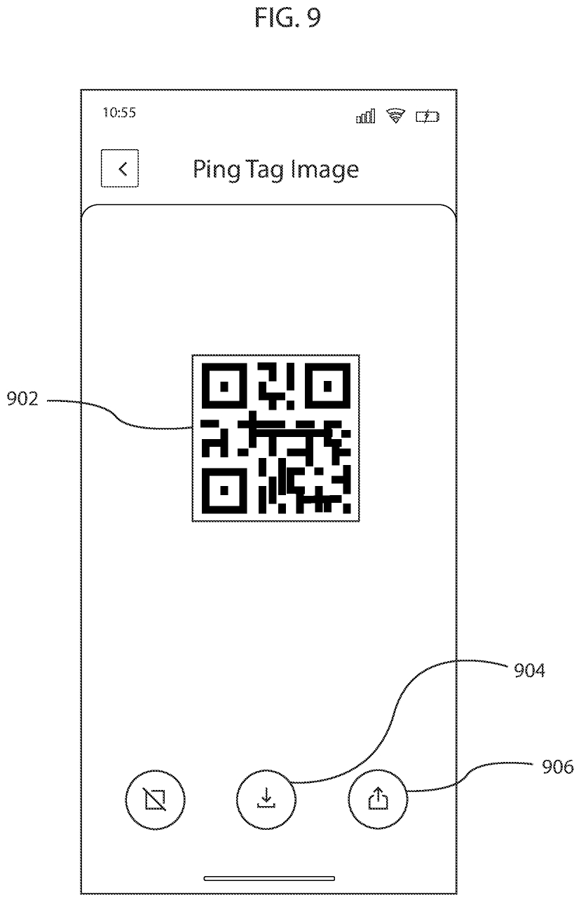

It is noted that the ‘<ping-tag-id>’ denotes the ping tag id previously returned from the call service system. Those skilled in the art should easily recognize that the URL references a web-based call app on the call service system for handling the call and the ping tag id itself identifies the call destination by retrieving the list of call recipients associated with the ping tag. This URL is then used to generate the QR code image when the user needs it. Refer to FIG. 9, which shows a sample QR code (902) generated from a ping tag. The user can download on their device for printing or share with others via other apps, e.g., email, chat, social network, etc. Although, QR code is used for demonstrating the present invention, those skilled in the art should recognize that any imagery code that can be recognized by the camera for translating into an Internet resource identifiable by using a URL for execution may serve the same purpose, e.g. bar code. Furthermore, the ping tag setup configuration as mentioned above is in its simplest form. Other options could also be added to the ping tag configuration to offer more functionality to the users, e.g., call method (audio or video call), etc. In this embodiment, the call is assumed to be a video call, i.e., call participants will receive and display live video stream of one another on the call conversation screen as depicted in FIG. 3. It is also noted that the tag profile data is optional. If the user skips the tag profile setup, the call will proceed to call establishment phase as described below immediately.

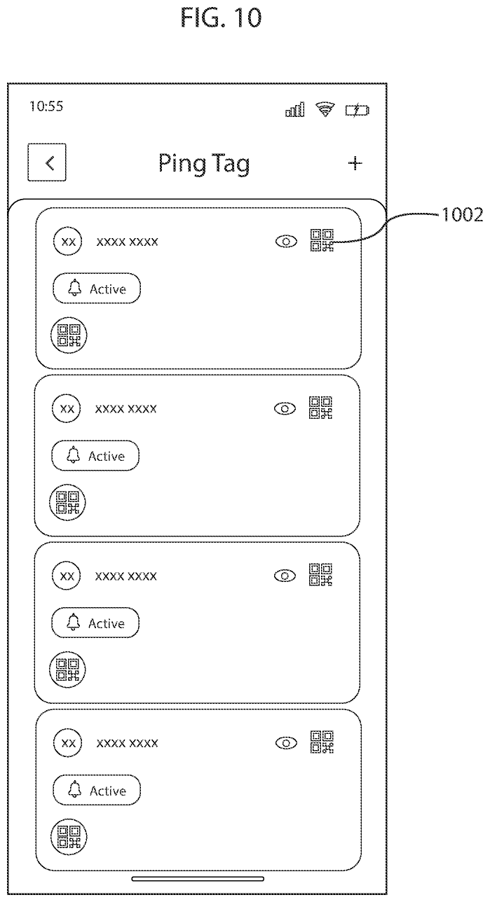

After a tag is created as aforementioned, the user can view the tag on a ping tag management screen as depicted in FIG. 10. This screen lists all the ping tags created by the user and generally allows the user to manage them through various operations such as View, Edit, Deactivate, Activate and Delete. The Edit function allows the user to edit a tag profile, call settings and call recipient list. The Deactivate function allows the user to temporarily deactivate a ping tag from receiving incoming calls from the tag. The Activate function will reactivate a deactivated ping tag by enabling it to receive incoming calls again. The Delete function is to delete a ping tag from existence. It is noted that once a ping tag is deleted, the user will never receive call from the tag again. Furthermore, the user can also view the QR code image associated with the tag by tapping on the QR code icon (1002). Back to FIG. 9, while at the ping tag image screen, the user can save (904) the tag image (902) to the device gallery or upload it for sharing with others (906) by uploading it to a web site, social networks or attaching it to an email message.

### 1.1. Ping Call

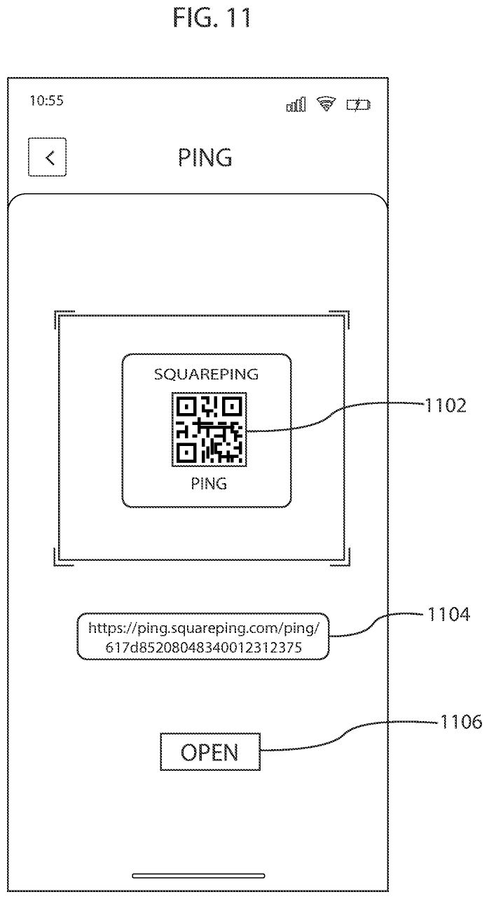

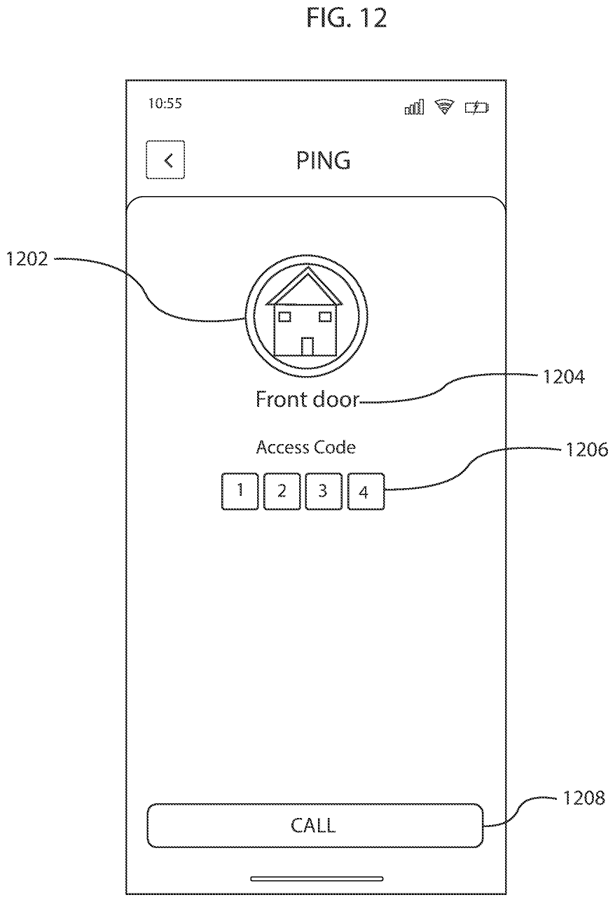

Now, refer to FIG. 11, which demonstrates the scanning of an Entry tag using the back-camera of a user's mobile device using SQUAREPING app. When the user positions the camera at an Entry ping tag (1102) for scanning using the app. As soon as the QR code image is in view of the camera, the app automatically reads and decodes it into the corresponding text string as shown in a popup panel (1104). As described earlier, the text string in this case is a URL for placing a data call to one or more call recipients identified by the ping tag id associated with the ping tag image. The user simply taps on the OPEN button (1106) to proceed with the call establishment process. This action causes the app to initiate an API operation using the aforementioned URL in order to retrieve the ping tag setup from the call service system for display on the next screen, aka. call screen, as depicted in FIG. 12. Since the ping tag is an Entry tag, the tag profile comprises a profile image (1202), the location text (1204) and access code (1206). In this example, the access code was preset, so the caller is required to input a correct access code for the call to take place. Tapping on CALL button (1208) triggers a Call Request API to be issued to the call service system passing the user id and the ping tag id in a call request message as demonstrated below:

```
{
  “message”: {
    “caller_id”: “XXXXXXXX”
    “ping_tag_id”: “YYYYYYYY”,
    “opcode”: “CALLREQ”,
    “access_code”: “1234”,
  }
}
```

It is noted that the call screen displays different information for different tag type. Access code is an optional field, it is prompted for input and verification only if it was preset by the tag owner. All tag types allow the user to specify optional alternate contact information such as email, phone number, social network id, etc. for reaching out to the user by other means if necessary. The alternate contact information is only displayed on the call screen if they are specified during the tag setup process. Such pre-call call screen is designed to give the user more flexibility in designing contact arrangement for specific application. However, those skilled in the art should recognize that, for certain applications, except for prompting the user for access code, proceeding directly to placing the call may be a preferred execution in order to minimize user's interaction and therefore, the intermediate call screen display may not be desirable or necessary in those scenarios.

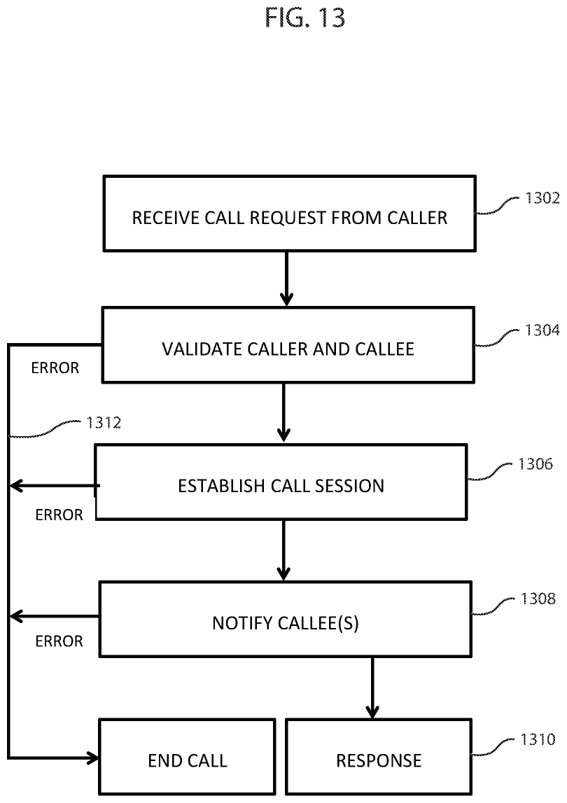

Now, refer to FIG. 13, which presents a flowchart describing call server processing of a call request. Upon receiving the call request (1302), the call server first goes over the parameter validation process aforementioned. Next, the call server then checks whether the caller is already in session with the ping tag by using the ping tag id and the caller id to query the call session table. If such a call session is still in session, i.e., not yet disconnected, the caller would reject the call request with an appropriate error code. Next, the call server then retrieves the call recipient list from the ping tag setup using the ping tag id (1304) and then pulls the call recipient list in the setup. If an access code is given in the call request, it will also be validated against the access code recorded in the ping tag, if any. If the validation process above fails for any reasons, the call server responds to the caller's app with an appropriate error code and ends the call (1312). After a successful validation process and there is at least a call recipient for receiving incoming call, the call server proceeds with setting up a new call session (1306) between the caller and the call recipient(s). To do this, first, the call server generates a unique call session id for the new call session. Next, the call server performs a series of actions to construct the call session management data such as adding the caller id and call recipient id(s) to the call participant list, recording the call-start timestamp, sending an incoming call signal (1308) to the device of every call recipient in the list, passing the caller id and call session id as below:

```
{
  “message”: {
    “caller_id”: “XXXXXXXX”,
    “opcode”: “INCOMING_CALL”
    “session_id”: “123456ABC”,
  }
}
```

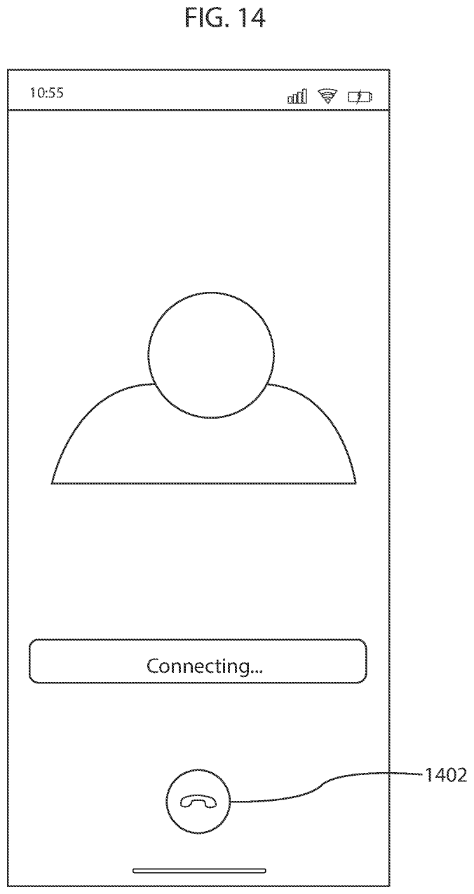

At this juncture, only the caller entry in the participant list is marked as ACTIVE to indicate the caller has joined the call. Conversely, all call recipient entries are marked as INACTIVE. Next, the call server sets a call timeout for disconnecting the call in the event none of the callees answers the call. Lastly, the call server sets the call session status to ‘CONNECTING’ and then responds to the call request with a success code along with the call session id (1310). If there is any error occurs during the call establishment process as described above, the call server will respond to the requesting caller app with a negative response along with an appropriate error code (1302). If the caller's app receives such a negative response, it will terminate the call and display a corresponding error message on the app's call screen so the caller is aware of the call failure. Assuming that the caller app receives a positive response from the call server, the caller app then proceeds with opening a persistent socket connection to the call service system for receiving future call signals from the call server, while it is setting up a live video stream of the caller's front camera and preparing for transmitting to a callee's device once a callee picks up the call. The video stream is transmitted using a video streaming protocol, which may be a server-centric or peer-to-peer protocol as aforementioned. Refer to FIG. 14, which illustrates the user interface screen of the caller app while it is waiting for the call to be accepted by a callee. The screen shows the live front camera view of the caller's device as transmitted to the callee(s)' device. At any time during the waiting period, the caller may hang up the call by tapping on the Hangup button (1402). When this happens, the caller app sends a Call Hang up signal to the call server passing the call session id it received from the call server earlier and closes the socket connection with the call server as well as shutting down the video stream. When the call server receives a Call Hang up signal from the caller app, the call server performs a sequence of actions for shutting down the call, which includes marking the session status as ‘DISCONNECTED’, records disconnect timestamp and sends a Call Disconnect signal to the callee(s)' app to end the call.

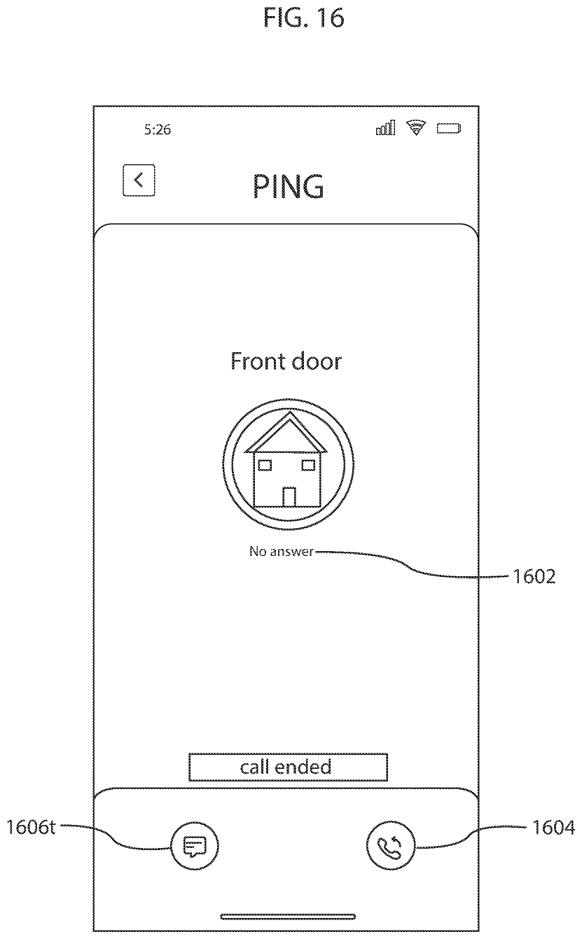

In the event none of the call recipients responds to the incoming event, the call session will eventually timeout causing the call service system to end the call by sending a No Answered signal to the caller app and a Call Disconnect signal to the callee app to end the call session on both ends of the call. As the caller app receives the No Answered signal from the call server, it performs a series of actions to end the call such as terminating the live video stream and disconnects the signaling socket with the call server. Then, it displays ‘No answer’ message (1602) on the call screen as depicted in FIG. 16. The screen also provides access to functions for redialing (1604) as well as leaving a message to the callee (1606) as a convenience to the user. The message will be delivered to callee(s) through notification mechanism available on mobile phones. Similarly, when the callee app receives the Call Disconnect signal, it stops ringing or playing preview video stream and releases all resources it holds such as socket connection with the call server, preview video stream, etc. and then displays a call-end screen on the device screen.

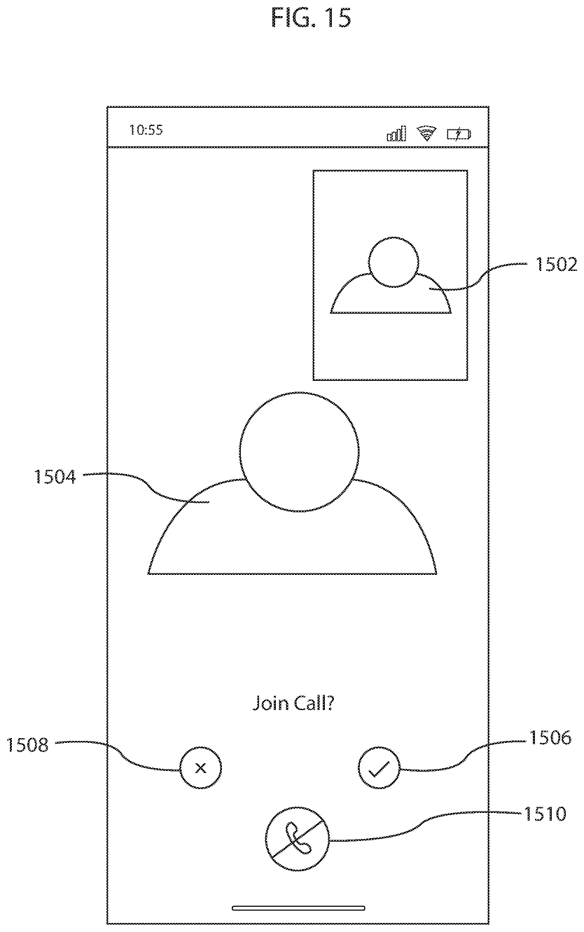

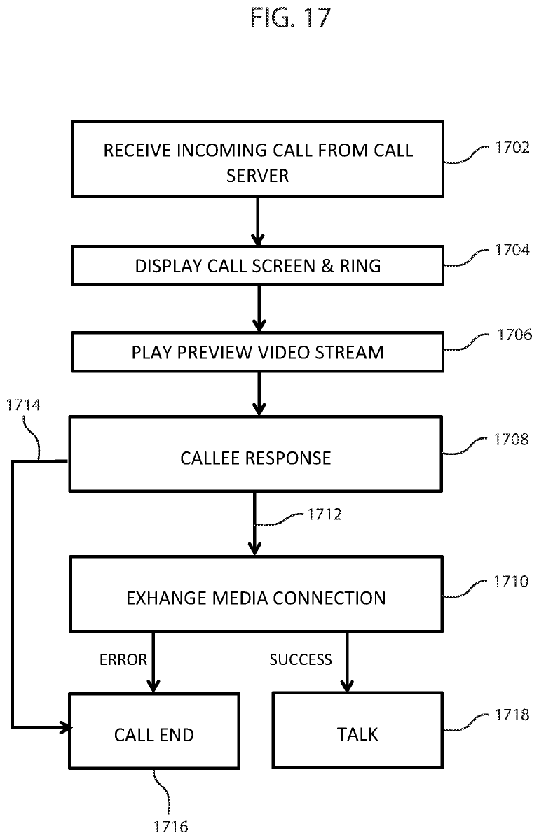

Now, refer to FIG. 17, when a callee's device receives the incoming call notification, the callee taps on the notification to start the app. Once started, the app displays an incoming call screen where the callee can either picks up the call or rejects it, while the incoming call continues to ring. The callee app also opens a socket connection with the call server for receiving future call signals from the call server. If the callee picks up the call, the callee app sets itself up for receiving and playing the live video stream from the caller (1706) as depicted in FIG. 15. This live video stream of the caller (1504) allows the callee (1502) to peek at the caller for identifying the caller as a safety measure. At the same time, the callee app also prompts the callee whether to accept (1506) or reject (1508) the call. It is noted, at this juncture, that the call establishment has not yet been completed between the caller and the callee. Therefore, the caller is not aware that the call has been picked up. The caller's screen will stay the same as depicted in FIG. 14 until the callee accepts or rejects the call. Optionally, the callee can also block (1510) a caller if so desired. Blocking a call from a caller will cause the call to be rejected and the caller to be permanently black-listed from placing call from the ping tag. It is noted that the same process as described above also happens on the device of every callee in the recipient list of a ping tag when an incoming call arrives. Back to FIG. 17, in the event a callee accepts the call, the callee app sends a Call Accept signal passing the call session id, to respond to the request (1712) as given in the example below:

```
{
  “message”: {
    “callee_id”: “YYYYYYYYY”,
    “session_id”: “123456ABC”,
    “opcode”: “CALL_ACCEPT”
  }
}
```

When the call server receives this signal, it looks up the call session table using the call session id, assuming the call session status is still CONNECTING, the call server changes the call session status to ‘CONNECTED’, records the call-start timestamp, marks the accepting call recipient entry in the call participant list as ACTIVE, then sends both the caller app and accepting callee app a Call Connected signal.

```
{
  “message”: {
    “session_id”: 123456ABC,
    “opcode”: “CALL_CONNECTED”
  }
}
```

When the caller and callee apps receive the Call Connected signal, they both start establishing and exchanging video and audio streams for entering conversational screen. Once the call has been accepted by callee, the call server sends a Call Disconnect signal to all other callees' device and terminates the socket connections with them, effectively blocking the other callees from any further interactions. When a callee app on a callee's device receives a Call Disconnect signal, it performs a series of cleanup operations for ending the call on the device as aforementioned. In the event the callee rejects the call (1714), a Call Reject API (call-hang up signal) will be sent to the call server as below:

```
{
  “message”: {
    “callee_id”: “XXXXXXXX”,
    “session_id”: “123456ABC”
    “opcode”: “CALL_REJECT”
  }
}
```

Upon receiving this signal, if the callee is the only call recipient, the call server changes the call status to ‘DISCONNECTED’ and then sends a CallDisconnected signal to the caller app for it to end the call (1716) as aforementioned. Otherwise, the call server will continue to wait for other call recipients' response until the call is timed out.
Back to FIG. 15, in the event the callee wishes to block incoming call from the caller, he or she taps on the Block Call button (1506). This action will trigger the app to issue a CallBlock signal, as given in the example below, to the call server and then execute a cleanup operation for ending the call.

```
{
  “message”: {
    “callee_id”: “YYYYYYYYY”,
    “session_id”: “123456ABC”
    “caller_id”: “XXXXXXXX”,
    “opcode”: “CALL_BLOCK”,
  }
}
```

Upon receiving this signal, the call server adds the caller id and the ping tag id associated with the call session to the black list table, which, in effect, prevents the caller from placing call using the ping tag in the future. Next, it sends a CallDisconnected signal to the caller's device to end the call. It is noted that only the owner of the tag would have the privilege of blocking an incoming call. Back to FIG. 17, assuming that the call was accepted, the caller's and callee's app will start exchanging live video and audio streams in accordance to the in-use protocol, i.e., server-centric or WebRTC peer-to-peer, (1710). Once the media stream connections are successfully established between the call parties, the caller and the callee can start talking to one another (1718). Those skilled in the art should readily recognize that the media stream negotiation and exchange processes are well-known prior arts, e.g., WebRTC, server-centric Jitsi video call server, etc. While the underlying media stream hand-shaking procedures may be slightly different from one architecture to another, the overall call signaling sequence as described in this embodiment is very much the same. Similarly, the call control operations represented by the call control buttons are also well-known prior arts.

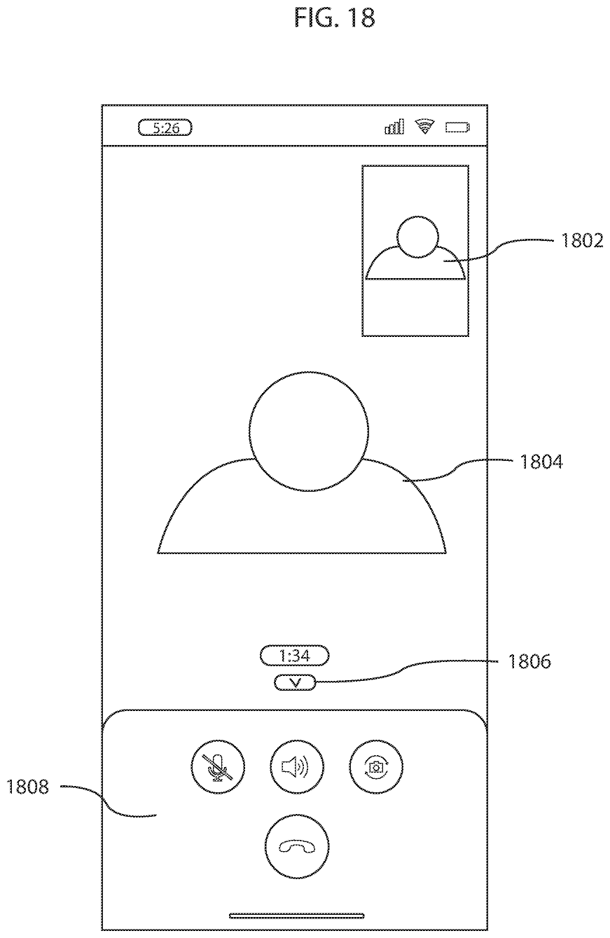

Refer to FIG. 18, which demonstrates the call conversation screen on the callee's device when a call is successfully established between the caller and callee. The caller screen similarly displays the video streams of both communicating parties. The smaller video window on the top right of the screen (1802) displays the video stream of the device owner, in this case, the callee, while the main video window (1804) displays the video stream of the other call party. There is also a expand/collapse toggle button (1806) on the screen for the user to gain access to the call control panel (1808). When the user taps on this button when the call control panel collapsed, the control panel will expand to display a number of control buttons that the user can tap on to control various call settings such as mute/unmute the microphone, enable/disable speaker, flip front/back camera producing the video stream, stop/start video stream, hang up the call, etc. Those skilled in the art should also recognize that other prior-art functions could be added to enhance user's experience while the call participants are in conversation mode, e.g., sharing location, sharing photo, video, image or document, etc. Later, when either the caller or callee hangs up the call, the app will send a CallHangup signal as given in the example below:

```
{
  “message”: {
    “participant_id”: “NNNNNNNN”, // Caller or callee id
    “opcode”: “CALL_HANGUP”,
    “session_id”: “123456ABC”
  }
}
```

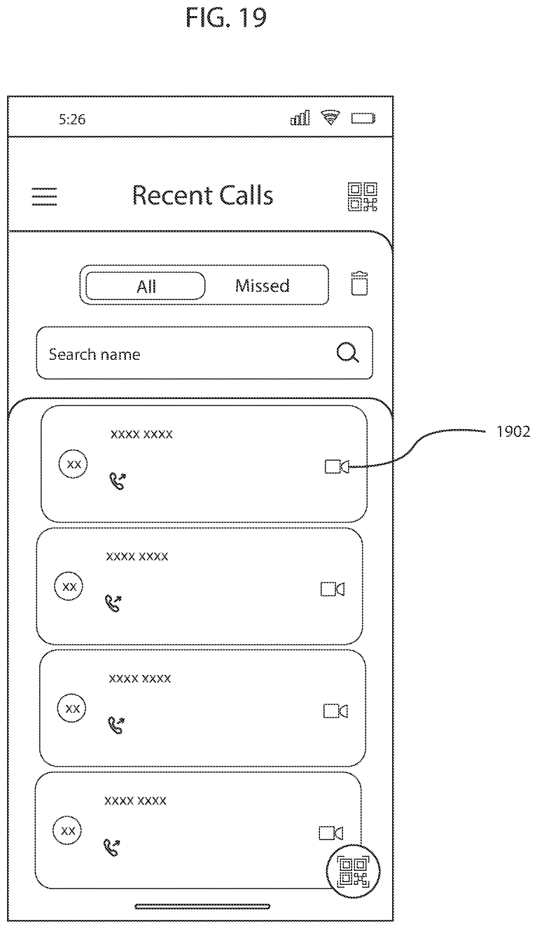

to the call server who then relays the signal to the other call party, effectively forcing both ends of the call to shut down own media streams and end the call. Meanwhile, the call server updates the status of the call session as ‘DISCONNECTED’ and records a call-end timestamp for the call session.
It is noted that, as a convenience to the app user, the app will log all incoming/outgoing calls for review and redial/callback (1902) by the user when needed as depicted in FIG. 19. Furthermore, although the app demonstrates a text message can be sent to a call recipient when there is no answer or when the call recipient is on another call session, those skilled in the art should recognize that voice and/or video message could be implemented in place of or in couple with the text message to give the user more options. The implementation of such types of messages are well-known prior arts. Typically, when such call failure occurs, the app could prompt the user to record a voice or video message, then upload the message to a cloud storage location determined by the call service system and then send a notification message to the call recipient with a URL link representing the location of the message embedded so that the call recipient can gain access the message when s/he receives the notification message. This message link could also be alternately or additionally recorded in the missed call session for the call recipient to access by going through the call history at a later time.

### 1.2. Call Mode

This embodiment describes a video call using a ping tag setup. At times, user may want a ping tag call being an audio call instead of video call for various reasons. Similarly, in some situations, user may prefer call to be made on mobile network instead of the Internet. Thus, in another mode of operation, a new ping tag setting, aka. Call Mode, is introduced so that the user can choose whether incoming ping calls coming from a tag is handled as an audio or video Internet call or mobile call. If the call mode of a ping tag is set to Video Call, incoming calls will be handled as previously described in the embodiment. In the event the call mode is set to Audio Call, incoming calls will be handled as an audio call only. That means the establishment and exchange of video streams for playing on the conversation screen are not needed and therefore, will be suppressed. If Call Mode is set to Mobile, the caller call will be made using the call recipient's mobile phone number instead. In this case, the call service system will provide the call recipient's phone number to the caller app for it to invoke the default phone app on the caller's mobile device passing the call recipient's phone number to it. In any cases, the preview video stream is still being played on the preview screen of the callee's device so that the callee can still peek at the caller prior to accepting an incoming call. After a callee accepts a call, the caller app will drop the live video stream to that particular callee's device, while the other callee devices continue to receive and play the preview stream until the call is either timed out, accepted or rejected.

### 1.3. Ping Mode

In another mode of operation, in case the call recipient list contains more than one entry, the present invention allows a user to select a call routing mode from a new ping tag setting, aka. Ping (or Call Routing) Mode. This setting gives the user more control of how an incoming call to be processed by the call service system. Thus, in this mode of operation, the ping tag setup record is extended to allow for this setting. The call routing mode dictates how a call request is being routed by the call server to a group of call recipients and accordingly, how to process them. There are three ping modes: ‘One-on-one’, ‘Conference’, or ‘Hunt’. ‘One-on-one’ mode is as described in the previous embodiment, i.e., the call server will notify all call recipients in the call recipient list of an incoming call request; however, the first callee accepts the call will take over the call. On the other hand, the ‘Conference’ mode will give all call recipients the option whether to participate in the call. This mode of operation is often known as conference call. Call processing handling for an audio/video conference call is a well-known prior art except for the handling of the preview video stream of the present invention. In prior art video conferencing, any call recipients can join the call at any point in time during the lifetime of a call. Thus, the present invention in this mode of operation must also provide support for this traditional mode of operation. Therefore, the preview video stream of the caller would continue to play on the device of any callees who has picked up the call regardless of whether any other call recipients has joined the call or not. When a callee decides to join the call, the call server will mark the callee entry in the participant list of the call session as ACTIVE. Simultaneously, the call server also relays the CallAccept signal it received from the new participant to the existing ACTIVE participants of the call. This signal will trigger the app on the receiving device to exchange media streams with the new participant's device and, if successful, update their own conversation screen to additionally play the video stream from the new participant. Similarly, the app of the new participant also plays the video stream of other ACTIVE participant(s) on its conversation screen. Meanwhile, callee(s) who have not yet decided to join or reject the call continue to see the caller's preview video stream playing on their screen. Later, when a call participant hangs up the call, the app on the participant's device sends a Call Hang up signal to the call server. Accordingly, the server will mark the hang-up participant status as LEFT. At the same time, it also relays the Call Hang up signal to all remaining call participants' device. Upon receiving the Call Hang up signal, the app on their device will stop playing and also relinquish the corresponding media streams associated with the leading participant on their own device. It is noted that those skilled in the art should recognize that, as a call participant joins (or leaves) a call, the conversation screen would be dynamically re-partitioned to make room for showing the video stream of the new participant on the screen or reclaim the space for better view of remaining participant(s).

The ‘Hunt’ mode is also well-known telecom call routing mode, in which the call server will ‘hunt’ for the first responder sequentially in a pre-determined order instead of broadcasting the incoming call request to all call recipients at once. That is the call server first dispatches the incoming call request to the first call recipient in the list that is not engaged in any call sessions. When an in-progress call request to a callee's device is timed out, the call server disconnects the call request and automatically re-route the incoming call to the next free callee's device in the listed order and so on . . . until either a callee picks up the call or the list is exhausted. The ‘hunt’ will also stop as soon as a callee accepts the call. In the event, no callee in the call recipient list accepts the call, the call server will send a Call Unanswered signal to the caller app for it to end the call. As such, the processing of an incoming call in ‘Hunt’ mode is very much similar to ‘One-on-one’ call, i.e., allow call to be established with only one call recipient, except for the additional ‘hunting’ process implemented by the call server as described above. It is noted that if Call Mode was set to Mobile, the Ping-Mode is fixed to one-on-one as other modes are intended for Internet call only.

### 1.4. Preview Mode

In some applications, such as lost & found, it may not be necessary for the call recipients to peek at the caller of an incoming call. Thus, to make user interaction simpler in such applications, in another mode of operation, the present invention extends the ping tag settings to include a setting namely, Preview Mode. Toggling this mode will enable the user to control whether an incoming call from a ping tag should precede with a live preview video stream of the caller. The call server is required to inform the caller's app whether this option is enabled in its response to a call request so that the caller's app will act accordingly. If the option is disabled, the caller's app will not attempt to construct and transmit a live video stream of the front camera of the caller's device as previously described.

### 1.5. Alternate Contact

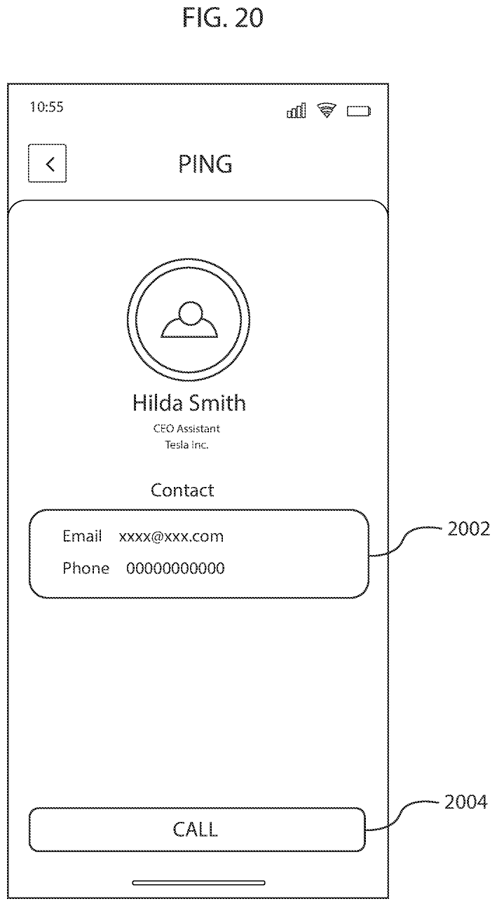

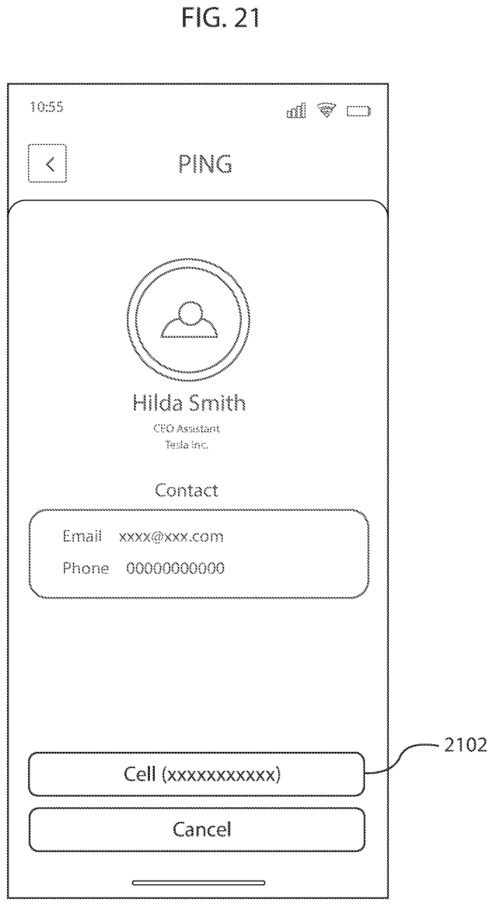

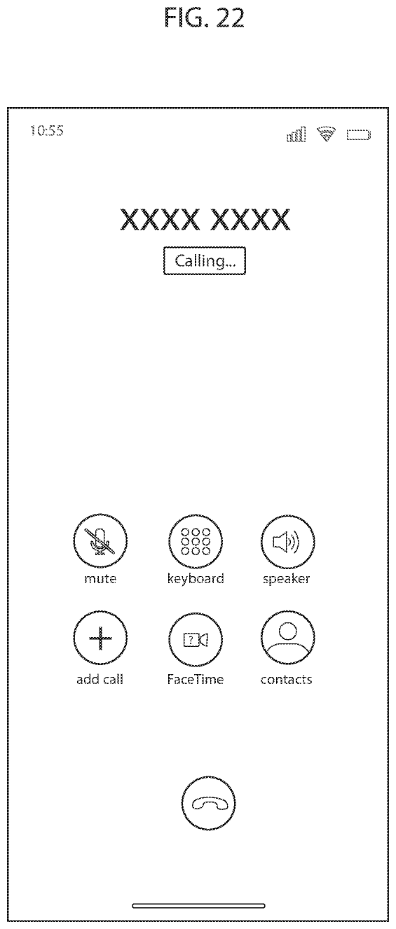

As aforementioned, a ping tag record includes optional alternate contact information such as mobile phone number and/or email address. This information, if present, can be used by visitor to place a mobile call or send an email message to the tag owner instead of placing an Internet call. While the information may seem redundant, they are useful as a backup in case the Internet is inaccessible on either side of the communication channel. A drawback of using alternate means of contact is, of course, the loss of video functions such as live preview video and video call. When a caller places a call by scanning a ping tag, the first screen s/he observes is as depicted in FIG. 20, where alternate contact information is displayed and accessible (2002), if available, as aforementioned. The CALL button (2004) is used to place data call via the Internet as previously described. However, if there are any problems with the data call, the call screen will reverse back to this screen for the user to have access to alternate means of contact in order to reach the tag owner. At the screen display, to place a mobile call, the user simply taps on the phone number. The action causes the app to retrieve the phone number and set up for placing a call through a series of API call made available by the phone OS vendors. For example, on iPhone, the app will use a CallKit framework made available by Apple for developer to setup receiving or placing a mobile call. Similar tool is also available for Android phone. In a user interaction scenario, the app responds to the phone-number-tapping action by showing a pullup menu for user to confirm the call as depicted in FIG. 21. Once the caller confirms the number to place the call (2102), the default phone app is invoked to place a mobile call to the given number as depicted in FIG. 22. Afterward, the user interacts with the phone app to complete the call. Once the call is hung up, the user can reverse back to the app as normally would. It is noted that mobile call is placed over VoIP system maintained by the mobile phone service provider and therefore, does not require Internet access. Those skilled in the art should readily recognize that other means of contact could be introduced as alternate contacts to further extend flexibility, such as popular social networks, e.g., LinkedIn, Instagram, Facebook, etc., and messaging platforms such as Snapchat, WhatsApp, etc. should both the caller and the tag owner are a regular mobile user of these platforms. Thus, in another mode of operation, a call of the present invention does not necessarily always to be a data call or a preferred method of placing a call. It could be either data or mobile call as described. In some circumstances, mobile call could be a preferred method for placing a call such as when Internet is not accessible or when mobile call is a preferred method of placing a call to preserve traditional call user interface that most users are already familiar and comfortable with, while data call is optional and only be invoked on user's command. That is, the order of call-placing methods is reversed from the description above. Alternately, the app, or a mobile phone app incorporating the present invention, could present a call screen that prompts the user to select whether a mobile call, if a phone number is provided in the ping tag, or data call, if Internet is available, to place a call after the ping tag is successfully scanned. A phone operating system vendor such as Apple and Google, can easily detect whether the user's device has Internet access or not using internal development tools.

### 1.6. Multi-Sessions

In the event multiple incoming calls are placed from the same ping tag, the present invention will process and handle them in parallel through the use of call session id as described in a previous embodiment, provided that the tag was set up with multiple call recipients. In this case, depending on Ping Mode setting, an incoming call will either ring on all available call recipient(s)′ device as aforementioned or hunt for an available call recipient for ringing while in-process calls are still going on. When an available call recipient picks up the call, the call is established as a new call session. Similarly, subsequent incoming calls can be established in parallel with in-progress call simply by repeating the same process, until the call recipient list is exhausted. In this case, the caller will receive a Busy signal. In another mode of operation, the incoming call will ring on all devices regardless of whether a device is in the midst of another call or not. In this case, the person on a call can temporarily put the in-progress call on-hold to accept the incoming call on another call session. Later, the call recipient can switch back and forth between the two call sessions. This mode of operation is a common practice in normal phone service. Those skilled in the art should recognize and be able to implement such a capability.

### 1.7. Message

In the event an incoming call is unanswered by a user of the app of the present invention, the present invention will allow the caller to leave a message to the user. The message can come in the form of a text, a voice or video message. Since message is associated with a call, the call session record must have space reserved for storing the text message itself or, in case the message is a voice or video message, a resource link (URL) to the location of the message where it would be stored. Typically, audio and video messages are stored as multi-media files in a mass storage system such as AWS S3 storage service. When a call is unanswered, the caller will be prompted whether s/he wants to leave a message and the type of message s/he wishes to leave on the call screen. The caller can choose leaving a message of one of the three message types as aforementioned. If a text message is selected, the app will prompt the caller to enter a text message. If voice message is selected, the app will prompt the caller to speak on the microphone for recording the caller's voice message. Similarly, if the caller selects to leave a video message, the app will prompt the caller to record a video message using the front camera and microphone of the device. Once the message input or recording is complete, the app will issue an API passing along the message content to the call service system for storing in association with the unanswered call session. Upon receiving request for storing the message and message content, the call service system will examine the message type in order to properly process the message content. For text message, the message will be stored in the call session record. For multi-mediate message, the media data will be uploaded to a storage system such as AWS S3 for storing and a resource link (URL) associated with it will be stored in the call session record. Once the message is properly stored and recorded as described, the call service system will notify the user of the app by both sending an email message to the user's registered email address and issuing a push notification message to the user's device. Both notification messages will contain linkage data to enable the user to open the message for viewing simply by tapping on the link or notification message. Those skilled in the art should readily know how to setup the app to collect a user's message using one of the discussed mechanisms, store it on the call service system and allow user's access to the stored message using the methods as described as these are well-known prior arts.

### 1.8. App-Less Setup

The app of the present invention was in effect hiding a tag owner's phone number from exposing to unknown callers by using Internet call instead of mobile call. The drawback to this setup is that the user has to download and install the app on their device for the Internet call to be made. A simpler setup could be presented when the call is made using mobile call instead of Internet call. In this case, a web app can be provided and accessible on the cloud network to allow the user to simply enter own phone number in association with the tag. The phone number could be that of the tag owner's mobile device or even a landline number. Thus, when the caller scans the tag to place a call, when the tag's CallMode is set to Mobile, the call service system will return to call recipient's phone number to the caller app. The call app then invokes the phone app on the caller's mobile device passing the phone number to it in order to place the call over the mobile network instead of an Internet call over data network. This setup has the advantage of being simpler and may be a preferred setup for most novice users but the drawback is, as stated, the user's phone number will be exposed to the caller.

Together, the optional settings are described above will transformed the ping record as below:

| { | |
|---|---|
| CreateTimestamp, | |
| LastUpdateTimestamp, | |
| TagId, | // Unique ping tag id |
| UserId, | // Tag owner - unique app user id |
| TagType, | // Entry, Pet, Asset, ID, Contact, ... |
| TagProfile { | // Optional profile information |
| ProfileImage, | |
| ProfileInfo, ... | // Vary on tag type |
| Contact { | // Optional alternate contact details |
| Name, | |
| Address, | |
| PhoneNumber, | |
| Email, | |
| SocialNetworkIds | // Twitter, Facebook, LinkedIn, ... |
| } | |
| } | |
| CallOptions { | |
| PreviewMode, | // On or Off |
| CallMode, | // Audio, Video, Mobile |
| PingMode, | // 1-on-1, Conference, Hunt |
| CallRecipients { | // List of call recipients |
| UserIds, | // if CallMode is Audio/Video |
| PhoneNumbers | // if CallMode is Mobile |

```
    }
  }
}
```

### 2. PingPad

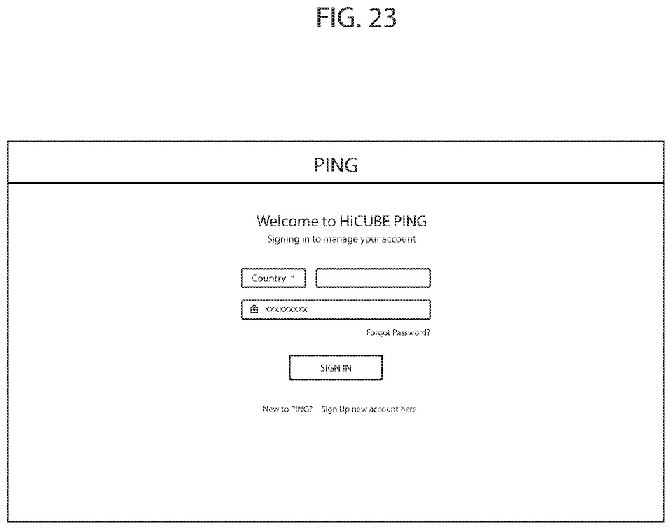

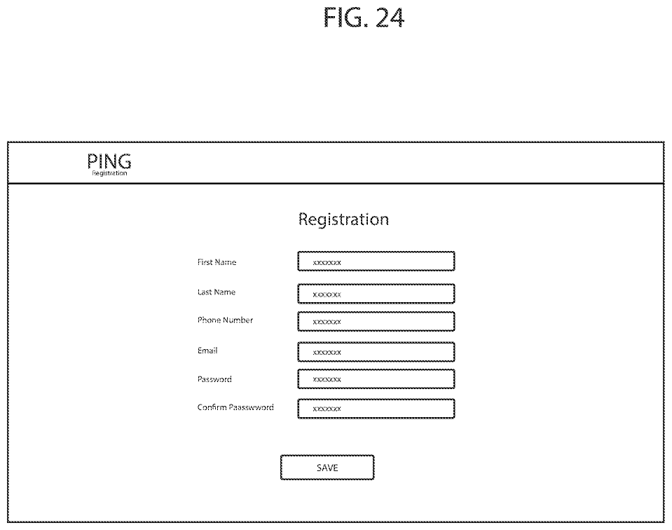

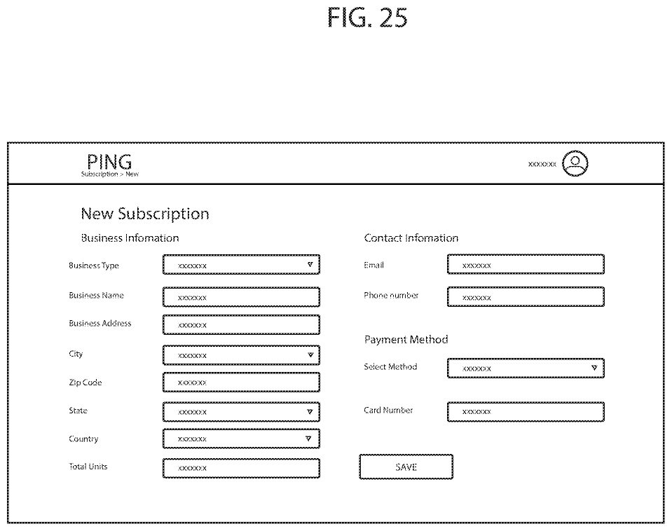

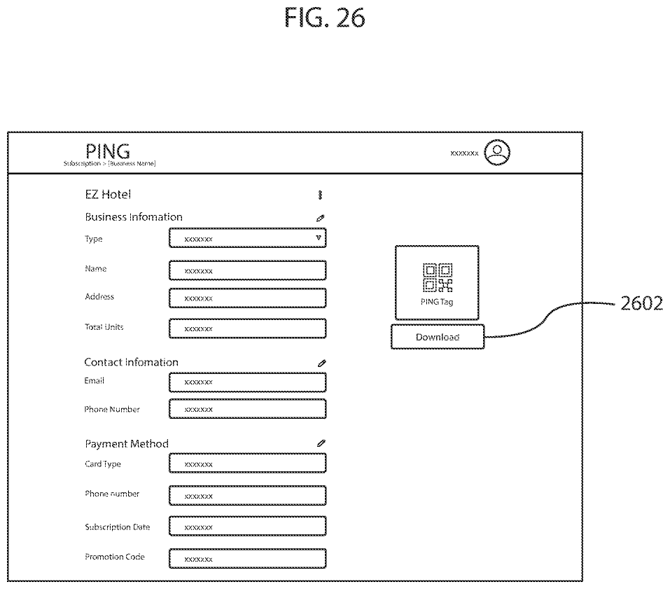

For entry tag, after a ping tag with QR code image is generated, the user can print it on paper and post it at the door entry where it is visible to visitors for scanning. While this method works fine for individual residential unit, in building complex with visiting lobby such as hotel, gated community, or office, it is desirable to have a way for visitors to place a call to a resident from the lobby or from security gate. Thus, in this embodiment, the present invention introduces a common or group ping tag, aka. PingPad tag, for living community and a system for routing visitor calls to a destined user's device in similar way as the telecom PBX system. That means every resident will be assigned a unique extension, or access code, that a visitor is required to enter to reach the intended resident or member of a business. The extension (or access code) could be of any reasonable length, e.g., 4 to 6 characters, of any printable char or numeric, alphanumeric or alphabet-only string. A new tag type, aka. PingPad, is introduced to provide support for access code-based call routing function. Access code (extension) can be as simple as a unit/room number. It could be a randomly-generated unique number or based on a scheme determined by the business administrator of a business. The access code of this embodiment serves as a call routing mechanism similar to landline phone extension. Similar to Entry tag, this tag profile also includes tag-posting location and an access code. To acquire such a ping tag, a business entity is required to register for service on SQUAREPING website as depicted in FIGS. 23 to 24. After a successful registration, the user then logons to the system to subscribe for service. The user will be presented with a form for entering information on the business such as business type, name, address, contact information, payment information, etc. as depicted in FIG. 25. Additionally, the user also specifies the total number of units/rooms (or extensions) required by the business. This information will be later used for generating unclaimed per-unit ping tags that will later be claimed by end-users, i.e., call recipients, for receiving incoming calls from visitors. Once the subscription was properly setup, the user taps on the SAVE button to submit the subscription request to call service system through a REST API passing the user account id and business subscription profile information as aforementioned. Upon receiving the request, the call service system generates a unique group id and assigns it to the subscription profile before saving it to the group table of the call service database. The group id will be set as the owner of the subscription, while the user who creates the group profile will be set as the owner of the group record. An owner of a group, of course, assumes full administrative authority on a subscription such as editing business profile, cancelling the subscription, change payment method, etc. Refer to FIG. 26, once the user submits the subscription to the call service center, assuming that the provided information are valid, the subscription will be created in the group table. Next, the business administrator sets up an extension scheme for the business. For example, a hotel could use room number as extension code. Similarly, an apartment or condo could use unit number as extension code. Once an extension scheme is decided upon, the business administrator can generate a series of ping tags marked as ‘unclaimed’ for claiming by the residents of the business. To provide support for group subscription, the ping tag entry is extended to contain at least the additional settings highlighted in boldface:

| { | |
|---|---|
| CreateTimestamp, | |
| LastUpdateTimestamp, | |
| TagId, | // Unique tag id |
| UserId, | // Tag owner - unique user id |
| TagType, | // PingPad, Entry, Pet, Asset, ID, ... |
| GroupId, | // Business (group) id |
| Business Type, | // Lodging, Residential, Office, ... |
| Extension, | // Extension or access code |
| Passcode, | // Extension claim passcode |
| Tag Profile { | // Optional profile information |
| Profile Image, | |
| Profile Info, ... | // Vary depending on business type |
| Contact { | // Optional alternate contact details |
| Name, | // Business name |
| Address, | // Business address |
| Phone Number, | // Business phone number |
| Email, | // Business email address |
| Website | // URL to Business website |
| } | |
| }, | |
| Call Options { | |
| Preview Mode, | // On or Off |
| Call Mode, | //Audio, Video, Mobile |
| Ping Mode, | // 1-on-1, Conference, Hunt |
| Call Recipients { | // List of call recipients |
| User IDS, | // if CallMode is Audio/Video |
| Phone Numbers | // if CallMode is Mobile} |

```
    }
  }
}
```

An unclaimed ping tag will have the User ID field of the ping tag will set to empty, the Group ID is set to the business (group) id, effectively assigning the business as the owner of the tag. For individual tag owner, this field is always set to empty. the TagType is set to PingPad and the Business Type field is set to the business type of the business profile. The Extension field will be set to a valid extension of the business call service for claiming by an assigned member of the business. For example, tag type Lodging is designated for temporary living space such as hotel, motel, hostel, etc., tag type Residential is designated for residential complex such as condo, apartment, townhome, gated community, mobile home park, etc., tag type Office is designated for business office in general. Finally, a PingPad QR code image could be generated from the subscription id. All other fields are set to empty for members of the business to set up with their own information and preferences. Once the Ping Pad tag image is successfully generated, the user can download (2602) the Ping Pad tag image for printing and posting at one or more desired location on the business premises. When a visitor scans the PingPad tag QR code image, the subscription id is retrieved for processing as described subsequently. It is noted that the subscription may have to go through a validation and verification process before it can be activated for use. During this time, the subscription will be suspended until explicitly approved by the system administrator either manually or automatically. This process may involve several manual and/or automated sub-processes for validating and/or verifying the provided information such as business entity, contact information, payment method, etc.

### 2.1. Ping Tag Claim Process

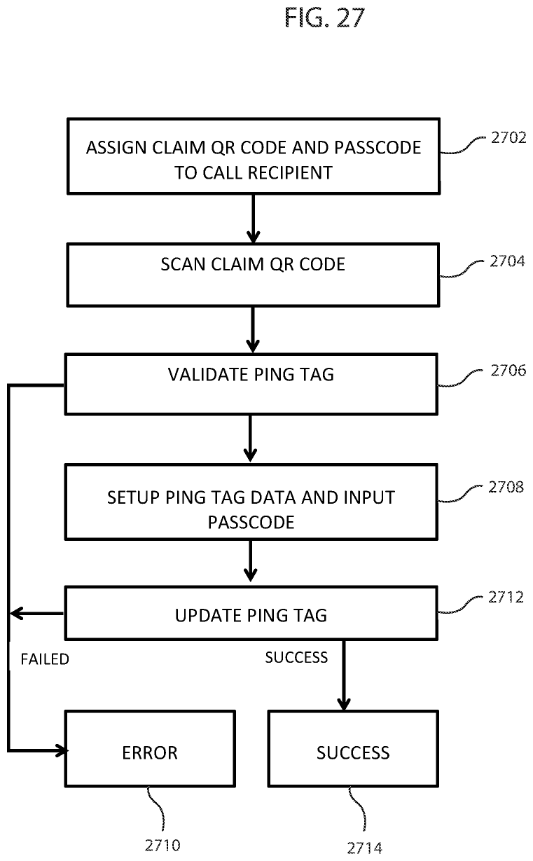

Before a member of a business, i.e. guests, residents, employees, etc., can receive incoming calls from the subscribed PingPad tag id, refer to FIG. 27, the call recipient of an extension must register as the owner of the extension using his/her mobile device. Thus, the business administrator must provide every member of the business a claim QR code image and a passcode (2702). The claim QR code image encodes an API call that can be used to retrieve the ping tag record associated with the access code (or extension) as given in the example below:

https://ping.squareping.com/claim/<ping-tag-id>

where the <ping-tag-id> identifies the ping tag record associated with an assigned access code. The passcode is used to confirm the identity of the claimer and thus, avoid fraudulent claim. The call recipient is required to install the app of the present invention on own mobile device and then uses the app to scan the claim QR code to start a claiming process that allows the user to setup a personal ping tag profile and associated call options. Once the user uses the app to scan this image, the encoded URL is retrieved and used to access the ping tag record from the call service system through an API call (2704). Upon receiving the request, the cal service system retrieves the ping tag record associated with the given ping tag id and, if the operation is successful, it validates whether the ping tag has already been claimed by someone else (2706). If ping tag has not been claimed, the call service system responds to the API call with a positive response and the unclaimed ping tag record to the app for claiming, i.e. setting up. Otherwise, it returns an appropriate error code to the app (2710). When the app receives the positive response from the call service system, it will proceed with prompting the user to set up the remaining unset information to claim the tag, i.e. tag profile, alternate contact information, call options and one or more call recipient (2708) as described in a previous embodiment. It is noted that the tag profile setup varies depending on various factors such as business type, tag setup policy administered by the business administrator, etc. For example, a business may want to include the business information on the tag profile, instead of that of individual member of the business, e.g., hotel. While another type of business may prefer the tag profile to reflect that of individual member of the business, e.g., an apartment. Once the call recipient finishes setting up the tag profile and call options, the app then prompts the user to enter the passcode before submitting the tag data and the passcode to the call service system using an API call for update (2712). If the provided data are valid. The call service system will set the User ID field of the ping tag to the requesting user id and finally updates the ping tag record in the database to complete the claiming process successfully (2714). Otherwise, it will return an error code to indicate the claiming process failure. The error code could be encoded to give information on the type of errors encountered. It is noted that the use of claim QR code to identify the unclaimed ping tag record is aimed to simplify the claiming process. Those skilled in the art should recognize that the same can be achieved by providing the call recipient the subscription group id and access code to identify the associated ping tag record. In this case, the call recipient is required to enter the subscription group id and access code to the app for it to retrieve the unclaimed ping tag record. It is also noted that a simpler setup without requiring the call recipient to install the app of the present invention is for the business administrator to associate a ping tag record with the phone number of a call recipient. This type of setup may be desirable for short-term lodging business such as hotel, motel, etc. where people check in and out frequently. In this case, the hotel receptionist can use an online form to enter a guest's phone number in association with an extension, e.g., room number where the guest stays. Visitor calls can later be established using mobile call procedure as described in a previous embodiment simply by entering the room number. When the guest checks out, the receptionist simply clears the phone number from the corresponding room number where they guest stayed to make it available for the next guest.

### 2.3. Call Handling Process

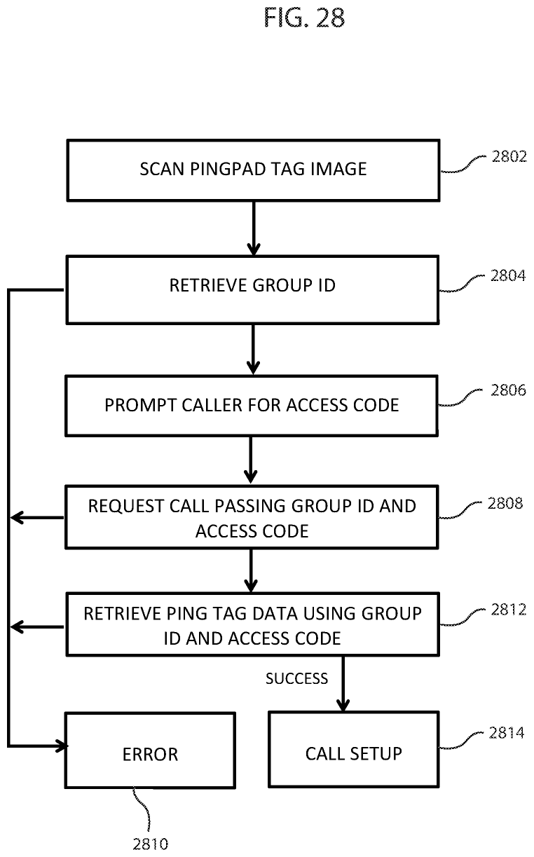

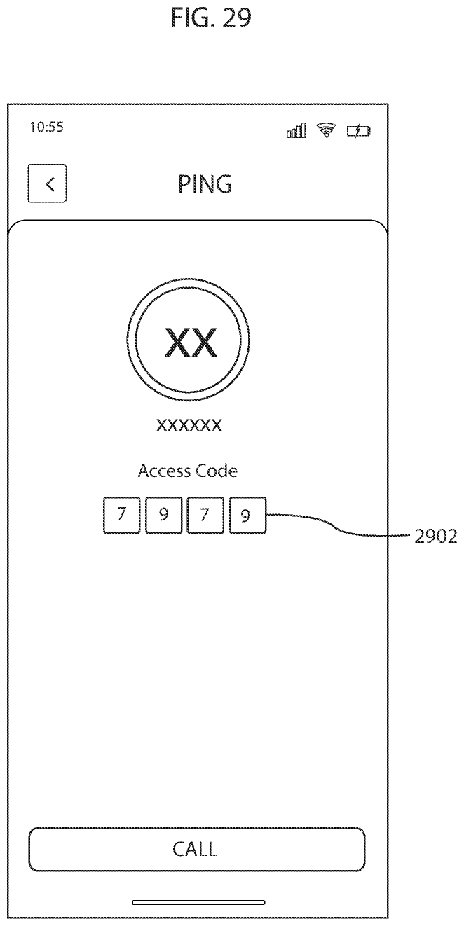

Refer to FIG. 28, when a visiting caller using the app of the present invention to scan the subscribed PingPad tag image (2802) posted, let's say, in the lobby of the business, the app will retrieve the PingPad tag id from the resulting URL (2004) and further prompt the user for an access code (2806). The prompt screen will display the tag profile of the business as depicted in FIG. 29. Once the caller enters the access code (2902), the app will issue a call request API to the call service system as described in a previous embodiment passing the PingPad tag id (or group id) and the access code as parameters (2808). When the call service system receives the request and associated parameters, it will use the given parameters to query the ping tag table for the requested ping tag setup. The operation will, of course, result in the personal ping tag setup that the call recipient created earlier as described above (2812). If the call recipient list is not empty, the call setup, routing and handling operations will occur as described in the previous embodiments (2814). Otherwise, if there is any error during the above process, the call service system will respond with an appropriate error code (2810). Optionally, upon receiving a positive response from call service system of a personal ping tag associated with the access code, the app could display the profile of the ping tag for the visitor to confirm the intended party actually before placing the call. A side benefit of this scheme is it also allow the visitor to have access to alternate contact information if given by the ping tag owner. This option could be available to the business administrator and/or the tag owner depending on the business' usage policy.

It is noted that the access code could be automatically assigned by the system among those have not been claimed in the system instead of a manual assignment process as described in this embodiment. That is once a call recipient acquires a ping tag as described in this embodiment, the app automatically selects an unused code by communicating with the call service system and then prompts the user for acceptance. At this point, the user could have an option to personalize the access code for easy memorization by entering another code of preference. If the new code does not match any existing access codes with the same tag id in the ping tag table, the system will accept and the user can proceed with other steps to setup the ping tag. Otherwise, the app will prompt the user to try another one. Such access code selection process is well-known prior art, those skilled in the art should know how to implement such process. It is also noted that this setup will allow for multiple incoming calls destined to the same extension to be processed and handled at the same time provided that end point device was set up with multiple call recipients. Furthermore, since the claimed ping tag is unique and personal, the call recipient can generate a ping tag image from the claimed ping tag for personal use. For example, it could be posted on the call recipient's door entry for visitors to place a call directly to the call recipient.

### 3.1. Unassigned (Pre-printed) Ping Tag

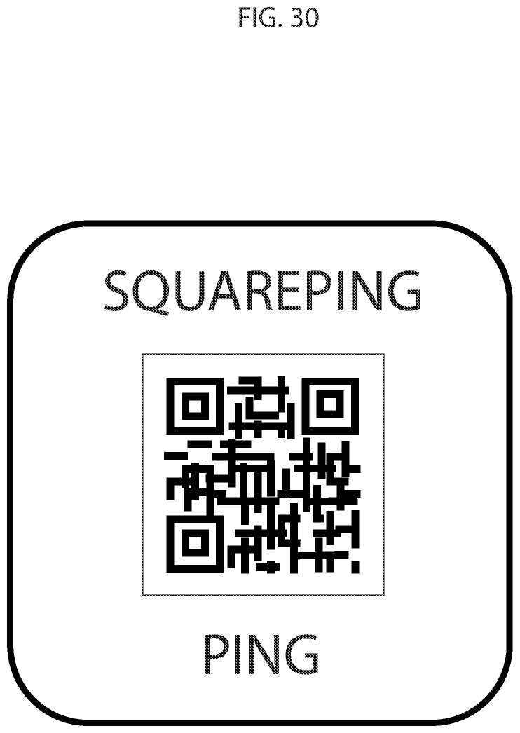

In another embodiment, the present invention allows the user to claim a pre-printed unassigned ping tag. This process will help to relieve the users from the trouble of printing ping tag as ping tags could be economically pre-printed by professional printing shop in bulk and in long-lasting materials for order by end-users. In this case, large bulk of unassigned ping tags will be generated ahead of time. Each of the unassigned ping tags will be assigned a unique ping tag id with the tag type set to UNASSIGNED and all other fields are left empty. The generated ping tags are then stored in the ping tag table ready to be claimed by app users at a later time. The ping tag id (of the unassigned ping tag) is then used to generate a corresponding QR code image as depicted in FIG. 30 for printing and distribution. As a reminder, the QR code image represents a URL of the below format as described in a previous embodiment.

https://ping.squareping.com/ping/<ping-tag-id>

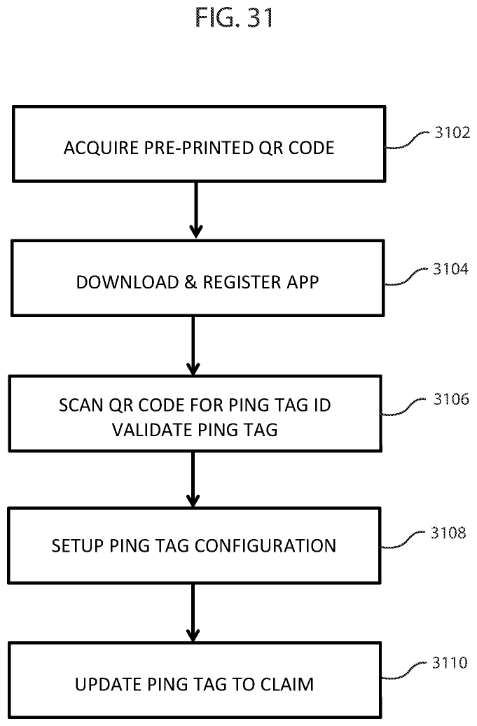

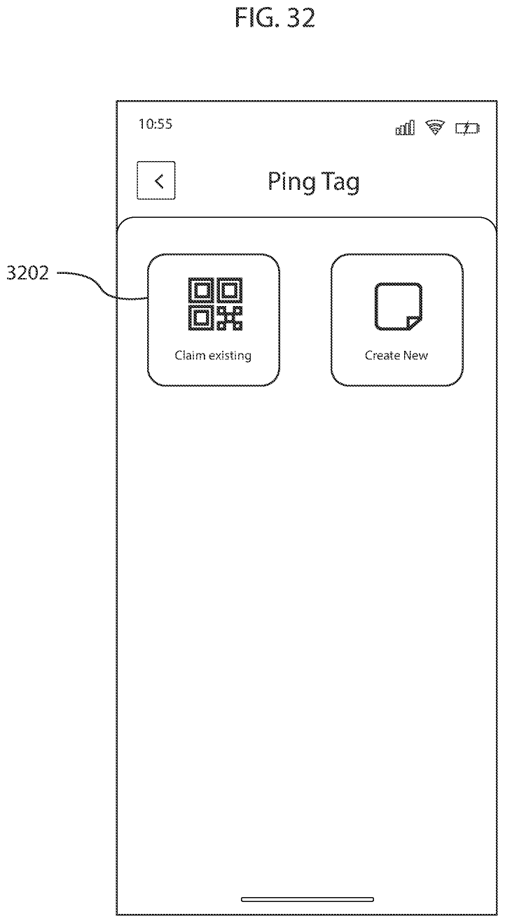

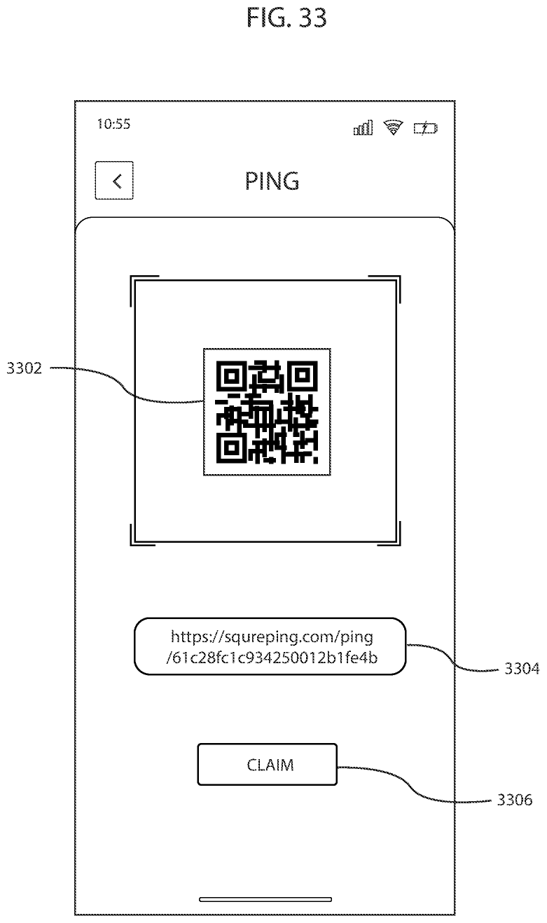

Now, refer to FIG. 31, which describes the process for claiming an unassigned ping tag. After a user acquires an unassigned ping tag label (3102), the user must first download and register the app and then use the app to claim the ping tag before it can be put in use. Once the app is installed and registered (3104), the user can use the app to claim an unassigned ping tag. First, the user uses the app to scan the QR code of the ping tag and parse the resulting URL for the ping tag id (3106). Next, the app issues a ClaimPingTag API passing the retrieved ping tag id to the call service system to verify whether the ping tag exists in the system and unclaimed. Upon receiving this request, the call service system will query the ping tag table for the ping tag specified by the given ping tag id. If the tag exists and the type of the tag is UNASSIGNED, the call service system will respond to the app with a positive response. Otherwise, it will respond with an appropriate error code. Assuming that the app receives a positive response from the call service system, it then proceeds with prompting the user for setting up the tag as described in a previous embodiment (3108). As a result of this setup, the tag type is updated to reflect user-selected tag type. Once the user completes the setup, the app issues an UpdatePingTag API to the call service system in order to save the tag to the ping tag table, passing along the ping tag id and complete user's setup data (3110). If this operation is successful, the ping tag is ready for use. FIGS. 32 to 33 demonstrate an example of the claiming process as implemented by SQUAREPING app. First, refer to FIG. 32, the user taps on the Claim Existing button (3202) to start the QR code scanning process. Then, on the QR code scan screen, refer to FIG. 33, the user positions the back camera of the user's mobile device on the unassigned ping tag (3302). Upon detecting and successful reading of the QR code, the app retrieves and displays the decoded URL (3304) on the screen as shown on the screen. At the same time, it scans the URL to retrieve the ping tag id. When the user taps on the CLAIM button (3306), the user will be prompted to select a tag type, followed by setting tag profile, call settings and selecting call recipients as described in previous embodiment. Once the user saves the ping tag to the ping tag table, it will carry the original tag id, but all settings are properly set by the user to his/her desired settings. Thus, the ping tag is claimed by the user. After a successful claiming process, the tag can be put in use as previously described. The call processing is exactly the same as described in previous embodiments. It is noted that, using this claiming process, any ping tag can be reclaimed (or reconfigured) provided that its tag type must be reset to UNASSIGNED, while the ping tag id remains the same. Such reclaiming process is useful in certain application settings such as motel, where guests come and go frequently, but the entry ping tags assigned to motel rooms stay the same.

3.2. Pre-Printed Ping Tag with Access Code

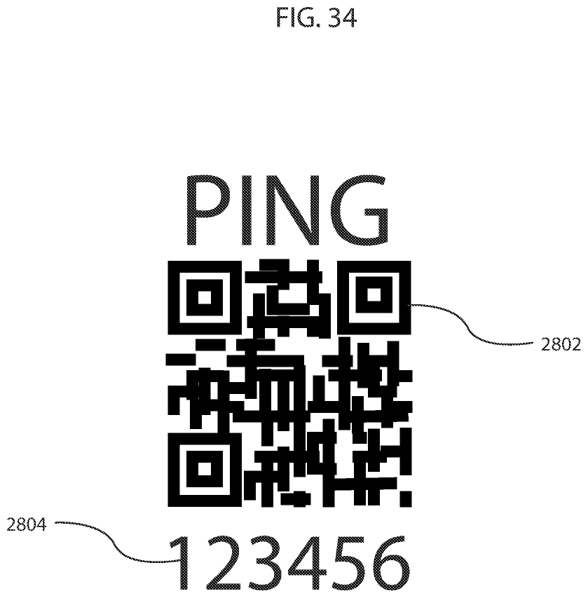

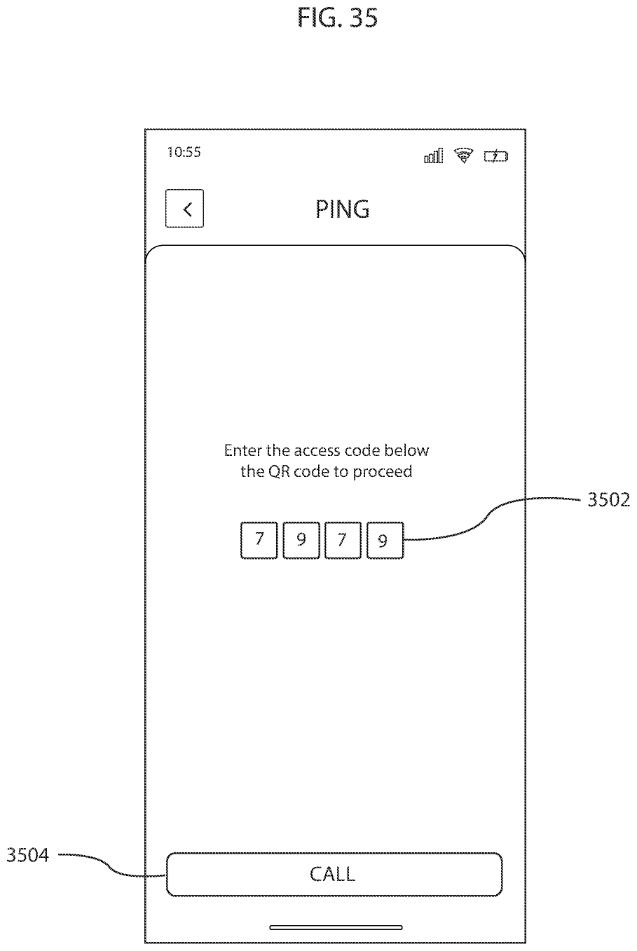

However, printing a unique QR code for every ping tag label in bulk as previously described may not be doable as many print shops are not equipped to do such printing in automated manner. Thus, this embodiment of the present invention introduces the use of a human-readable unique access code in combination with a common QR code in order to differentiate one ping tag from another as depicted in FIG. 34. Since the QR code is now the same for every ping tag in print, it would overcome the limitation of many print shops. However, in order for the system to differentiate one ping tag of this embodiment from the others of the same QR code, a unique access code will be introduced and printed along with the common QR code on every ping tag label as depicted FIG. 28. The QR code (3402) is the same for every ping tag of this embodiment, but the access code (3404) is different from for every ping tag in print carrying the same QR code. Printing such a ping tag is much more cost-effective as the access code could be programmed to be consecutively increasing for subsequent ping tag labels. As given in the example, the access code is a decimal number of 6 decimal digits. This allows up to around one million ping tags to be printed in bulk using the same QR code. The access code could be of any reasonable length, e.g., 4 to 6 characters, of any printable character or numeric, alphanumeric or alphabet-only string. The common QR code itself is, of course, associated with a ping tag of which ID is used to generate the QR code as previously described. This ping tag of this QR code, aka. master ping tag, must be created in the system as a place holder with all fields except for the ping tag id are set to default value or left empty. The access code would be set to all zeros to indicate that it is a master ping tag. It is noted that this process requires only the master ping tag to be initially created for printing, while the rest will be created on demand as users are claiming the printed label they receive at a later time. Later, a user who acquires a ping tag label of this embodiment must use the app of the present invention to go through a ping tag claiming process. This process involves scanning the label, validating it as an unclaimed ping tag with the system and then creating a ping tag associated with it. The app of this embodiment must be able to use the device camera to scan the print label and detect both the QR code for the ping tag id and the access code on it. Those skilled in the art should readily recognize that the app scanner could be implemented perform such function as libraries for number recognition are available from a variety of developer community. It is important to automate this process through the scanner in order to prevent user from mistyping a wrong access code that could result in claiming a wrong unclaimed ping tag. Once both the ping tag id and access code are identified, the app uses the ping tag id and the access code as a key pair to validate with the system that it has not been claimed by any users and, if so, continues to interact with the user in order to complete the ping tag setup as described in a previous embodiment. Once the setup is complete, the app interacts with the call service system to create a new ping tag with the ping tag id and the access code of the ping tag are set to those retrieved from the ping tag label. Other setup data are set in accordance to user's input. The ping tag id and access code pair will later be used by the system to locate the ping tag setup for routing incoming calls to the user as described in a previous embodiment. When a visitor scans the tag label using the default camera app of his/her mobile device, only the QR code is recognized. However, when the resulting URL is tapped on by the visitor, the app will be invoked and it will learn from the call service system that the ping tag id is not unique. As a result of this discovery, the app will prompt the user for access code as depicted in FIG. 35. Alternately, instead of prompting the visitor to enter the access code, it could also prompt the visitor to position the back camera of the device to scan the tag again using the app scanner, which is capable of retrieving the access code from the label automatically. Either way, once the access code is entered (3502), the app then enables the call button (3504) for the visitor to place the call as described in a previous embodiment.

### 4. PING Doorbell

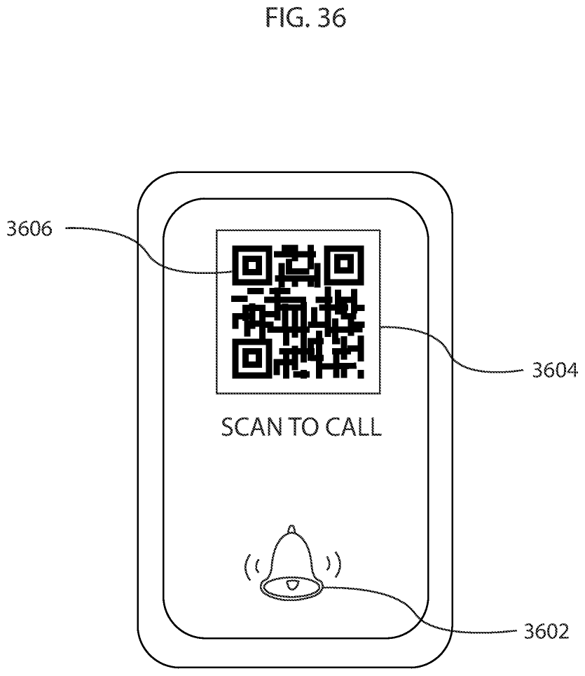

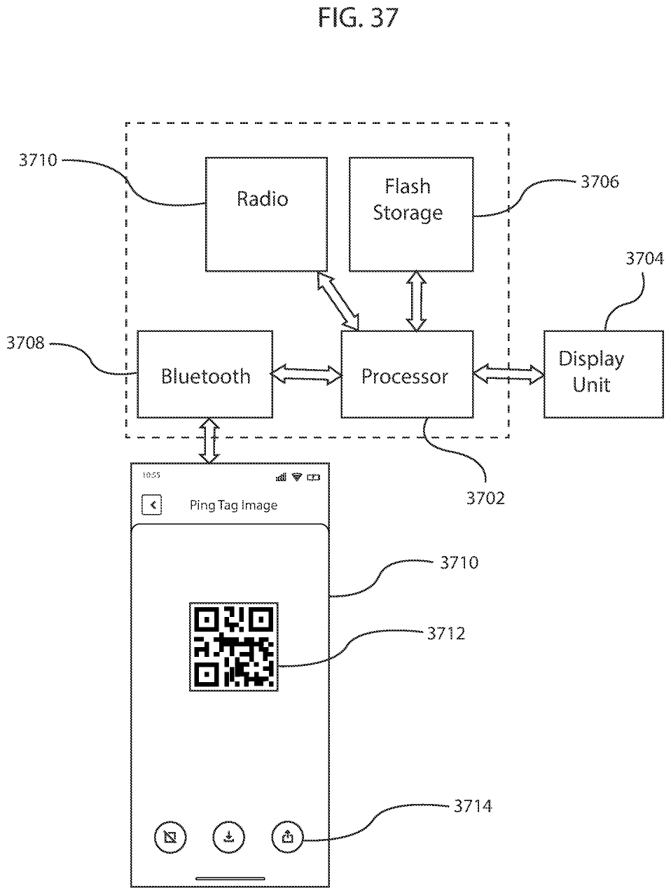

In another embodiment, the present invention is further extended to allow ping tag QR code to be electronically stored and displayed on electronics or a smart device such as a doorbell, smart ID card, etc. Such function will make it easy for user to change an existing QR code with a new one or program a new device with a ping tag created by the app without going through the nuisance printing task. Refer to FIG. 36, which illustrates a typical outdoor wireless doorbell of the present invention. Most common wireless doorbell has only a ring button to send a radio signal to a receiving device installed inside the home triggering it to ring the bell. However, the doorbell of the present invention includes a ring button (3602) and a small graphical display (3604) for displaying the QR code (3606). The display should be arranged to offer sharp contrast background, e.g. white background and black QR code or vice versa, for easy QR code reading by scanning device. Refer to FIG. 37, which illustrates a block diagram of the components of a low-power SoC (single chip computer) controller, e.g. Nordic nRH52832, of the outdoor doorbell unit of the present invention doorbell (3702) capable of executing program instruction and Bluetooth communication. The display is a graphical display (3704) with screen size as small as 1″×1″. The Bluetooth module (3708) provides a communication channel between the processor and a mobile device running the app. The radio unit (3710) is used to send radio signal to the indoor device for ringing the bell when the bell button is pressed on. The processor interfaces with the other units of the system via an internal system bus. It is noted that the diagram shows only components relevant to the description of this embodiment. Other components such as RAM, power supply module, etc. are not shown in the diagram. With such a smart device, a user's mobile device such as a mobile phone (3710) can detect the device and pair with it for communication via a messaging protocol over Bluetooth signals. Once the devices are paired, the user then uses the app to set up a desired ping tag as described in a previous embodiment and trigger an upload operation by tapping on the Upload button (3714) to upload the resulting QR code image (3712) to the doorbell device. Upon receiving a complete QR code image, the device stores the QR code image in place of old one, if any, in persistent flash memory (3706). The device also loads the new image on the display, making it ready for scanning. In subsequent device power-ups, the QR code image will be loaded as part of the device startup process. Later, the user can repeat the same process as described above to replace the image on the device with a new one. In addition, since anyone with a Bluetooth-capable mobile device can pair with the doorbell device within certain distance (around 100 meters), in order to prevent unauthorized change to the QR code image, a security protocol between the user's device and the doorbell must be introduced. This protocol could be as simple as having the doorbell device to send a message triggering the app to prompt the user to set a passcode if a passcode has not been set and stored on the device. Once the passcode is submitted by the user as the result of the prompt, the app sends it to the doorbell device for storing in persistent flash memory of the device. Afterward, whenever the user attempts to upload a new QR code image to the doorbell device, it must be accompanied with the passcode for the upload operation to proceed. In the event the user forgot the passcode, the user must contact customer support for a secret master passcode. The master passcode is generated by a secret algorithm, e.g. hashing, based on the serial number of the device. Both the serial number and the master passcode are stored in flash memory during manufacturing process. As such, customer support can generate the master passcode when the customer provides the serial number of the device. Once the user specifies the master passcode during a reset passcode operation, the device will update the passcode with the new passcode, effectively replacing the old one. Those skilled in the art should recognize that the hand-shake protocol over Bluetooth is a well-known prior art, so are the upload image process, secret passcode generation and passcode management as described above. Furthermore, a small solar panel unit could also be integrated with the doorbell device in order to extend the battery life for user's convenience.

### 5. Baggage Recovery System

Presently, the current standard practice for airline personnel in handling of unclaimed baggage and personal belongings left on Airplane is to report them on a lost & found system with the hope that the owners will eventually contact airline in order to claim the lost baggage/personal belongings and to initiate the recovery process. Yet, in many cases, the passengers often do not know where to contact to report baggage loss, not to mention if their stay at destination is not in the proximity of the airport and therefore, often take quite an effort to recover the lost items. Some passengers even gave up on reclaiming their baggage simply because the cost of recovery is higher than the cost of the baggage itself. In these cases, the airline industry is liable to keep the baggage for some period of time, usually 30 to 90 days, before auctioning them for recycle. Similarly, when a baggage is identified as ‘unclaimed’, airline personnel are often unable to contact the baggage owner to start the recovery process. This problem is amplified, especially, on international flights where: Passengers' baggage may arrive at destination later than the passengers themselves due to baggage mishandling on flight change and Passengers' contact information at destination is often unknown at departure check-in time. Needless to say, the problem creates extreme inconvenience and frustration on the passengers as it may take several days or even weeks for recovery of their baggage. According to Statista, the United States airline industry lost a hefty amount of $2.5 billion annually in handling, warehouse storage, refund of baggage fee and compensation of unclaimed and loss baggage.

Thus, in another embodiment, the present invention offers a solution to solve this problem by linking passenger's baggage to passenger's mobile device using the PING tag system of the present invention. In a setup for solving this problem, refer to FIG. 30, after the baggage are checked in with the airline check-in system using normal procedure, the airline check-in system will issue an API call to SQUAREPING system to request a PING tag and a claim code passing along the airline, the passenger identifiers and other baggage loss reporting contact information. The server will store these identifiers in the PING tag record; thus, the PING tag record in this embodiment must be extended to contain these identifiers along with baggage loss reporting contact information, e.g., a REST API call to lost & found system for baggage lost report or a link to the airline lost & found system for online report or a phone number to the lost & found center of the airline or a combination of these information. The identifiers will later be used to retrieve airline contact information for baggage claim as well as passenger's baggage tracking information. While the baggage loss contact information are to make it easy for passenger to report baggage loss when such event occurs. The PING tag will be generated using the same URL scheme as described in a previous embodiment. However, at the time of its creation, passenger's app user id is not yet known so it is considered as an unclaimed PING tag until claimed by the passenger. To protect passenger baggage from fraudulent claim, an access code of the PING tag is set to a code that the passenger easily knows, such as the last 4-digit of passenger passport or month and date of passenger birthday, etc. The app will prompt the passenger for access code in order to confirm the passenger identity during the claiming process. The QR code image of the claim code is generated using the URL with the format as given in the below example:

https://ping.squareping.com/claim/<ping-tag-id>

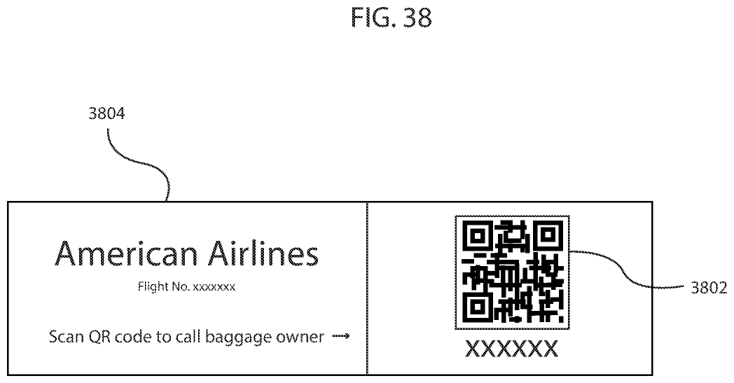

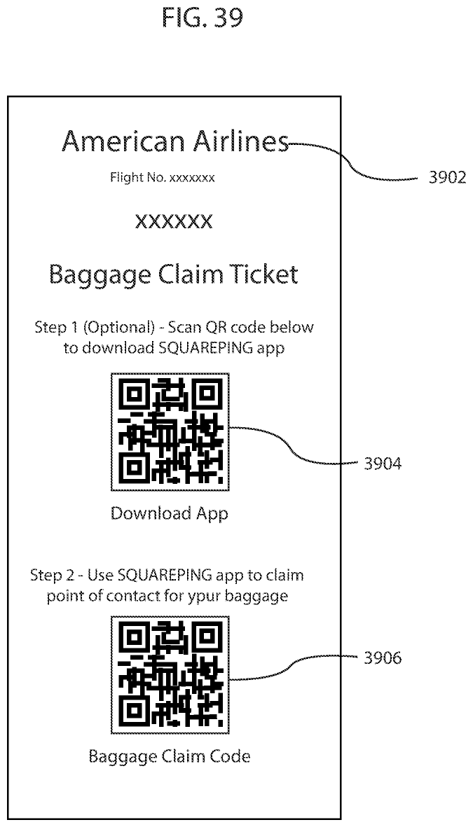

The <ping-tag-id> is retrieved from PING tag or returned from the API call. The ‘claim’ route element of the URL invokes the claim handler on the service system for handling the contact point claiming process. Later, when the passenger scans the claim code using the app of the present invention, this process is invoked to set the PING tag owner to the user identifier of the app, making the app of the present invention on the passenger's mobile device eligible to receive incoming calls from the associated PING tag.
If the PING tag request API call is successful, a PING tag id, the corresponding PING tag and claim code QR code images will be returned. Refer to FIG. 38, the PING tag image (3802) is printed on one or more baggage label (3804) and attached to every baggage that a passenger checks in, one label per baggage. Similarly, the airline ticket counter also prints a baggage claim ticket as depicted in FIG. 39. The baggage claim ticket (3902) will be handed over to passenger along with the boarding pass. The ticket contains a claim QR code (3906) that the passenger can scan using the app of the present invention on the passenger's mobile device to claim as the contact point of own check-in baggage. In the event the passenger does not yet have the app of the present invention installed on own mobile device, the passenger can use the mobile device camera to scan the Download App QR code (3904). This code will lead the web browser on the passenger's mobile device to either App-store or Play store in order to install the app on the passenger's device. After the passenger scans the claim QR code to claim point of contact as described in a previous embodiment, the tagged baggage is effectively linked with the passenger's mobile device via the PING tag. Whenever, someone, presumably an airport personnel, scans the PING tag, a call can be made directly to the passenger via either an Internet or mobile call depending on passenger's preference settings as described in previous embodiment. After successfully claiming as contact point for the PING tag, the app allows the passenger to browse the PING tag information which includes passenger profile, e.g., name, contact information, . . . , and check-in baggage. While browsing this information using the app, the passenger can, of course, access and update contact information, e.g., passenger's phone number, passenger's place of stay at destination, etc. so that airline personnel can reach out to the passenger for unclaimed baggage and even arrange delivery of the baggage to the passenger's location. The passenger can also easily report loss baggage with a tap of a button that will either invoke the baggage loss report API, or to gain direct access to the airline lost & found system on the cloud, or to make a phone call to the airline's lost & found center to report the problem, depending what information is available from the airline at setup time.

In another mode of operation, in the event the passenger does not want to install the app of the present invention, a web app can be used to allow the passenger to browse information associated with PING tag, update contact information and report baggage loss instead. However, in this case, the contact call initiated from the PING tag can only be made on mobile network. To invoke the web app, the passenger simply scans the claim code using own mobile device camera. Since the app user id is unknown in this case, the web app will prompt the passenger for access code to confirm the passenger identity before proceeding to gain access to passenger's contact information and check-in baggage as well as to report lost baggage or to access lost & found system in search of own lost baggage and/or personal belongings left in the airplane or around airport perimeter.

The processes as described in the embodiments above, along with the application settings and user interface design, are for the purpose of illustrating the present invention only. They should not be construed as a limit to the present invention. For example, the ping mode processing could be extended for accommodating additional call handling methods such as call forwarding, which could forward the incoming call to one or more call recipient other than the tag owner in a call recipient list. The tag types can be expanded to include additional tag types for various item categories and applications. The tag profile data can be customized to be more useful for specific applications. It is even better if the user is able to define own tag type and profile by interacting with a tag design module. Furthermore, the app of the present invention could also include an interface for controlling property's entry point, such as opening or closing the door or security gate. Technology for entrance control mechanism through wireless network, such as WIFI and the Internet, are already well-known prior art. Similarly, the app could also incorporate location sharing function to allow interacting users to quickly share location with one another. Such function is particularly useful for lost & found type of application. On the same token, functions such as logging of caller snapshot photo or preview video, call recording can be easily added for improved security, audit trail and training purposes. Those skilled in the art should readily know how to integrate the above functions and others with the app for additional functionality. As mentioned throughout the description, the call system used to demonstrate the present invention is a data call using either a peer-to-peer or server-centric protocol. However, those skilled in the art should readily recognize that the underlying call system could also be implemented using a mobile call via a VoIP system such as Asterisk VoIP system for gatewaying to PBX systems that allow incoming calls to be routed to a phone handset such as an office phone. It is also obvious to those skilled in the art that all data channels between the call parties can be setup for using one of the established industry standard end-to-end data encryption methods to enhance security and privacy of user's conversation over the call. These channels include call audio and video streams, messaging data and even location data shared over a call session. Those skilled in the art should also recognize that, although separately described in separate embodiments, the described embodiments could be selectively combined or additionally extended for enhanced user's experience, preferences and convenience. For example, a messaging function could be integrated to the app so that caller and callees can conveniently communicate and exchange information such as document, photos, videos and location data during or after a call. Such messaging function allows the user the flexibility of choosing whether a contact point, i.e., ping tag, should be conducted over a call or via messaging during a ping tag setup process. It also gives the caller the same flexibility.

Thus, it is now becoming apparent that a QR code image can be used to quickly establish an audio and/or video call between a visiting caller with the owner of the code without exposing the phone number of either side. When comparing the methods of the present invention against a camera doorbell device, the present invention has a clear advantage that it does not require additional hardware, while offering very much the same benefits as a camera doorbell device does. Furthermore, this method of the present invention also gives the users great flexibility for managing own privacy in a wide variety of situations, where a camera doorbell is not suitable. Yet, the implication of the present invention extends such benefits much further than those mentioned above as the QR code can be used to prevent exposure of user's phone numbers in many situations, especially, in online activity. On the application side, it is apparent now that QR code can be used as contact point in various applications, not necessarily limited to entry security. Examples of such applications are lost & found, online/offline contact tag, customer service tag, ID tag, etc. Thus, in this sense, the app of the present invention could be thought of as a contact management app, where the user can create many contact points, each for a different purpose. Such capability is like having multiple phone numbers on the same device without the complexity dealing with multiple SIM cards and their physical limitation. Furthermore, when coupled with access code-based call routing service as described in an embodiment, the present invention could serve as an Intercom system without the hardware and associated wiring of traditional Intercom system. Furthermore, the present invention could be applied for many order-taking and service applications where self-serve stations are in use, such as at hospital, government office, etc. in order to reduce cost, relieve long waiting line and improving service processing time all at the same time as described in a previous embodiment. While the invention has been described in connection with what is presently considered to be the most practical and various embodiments, it is to be understood that the invention is not to be limited to the disclosed embodiments, but on the contrary, is intended to cover various modifications and equivalent arrangements included within the spirit and scope of the appended claims.

This written description uses examples to disclose the invention, including the best mode, and also to enable any person skilled in the art to practice the invention, including making and using any devices or systems and performing any incorporated methods. The patentable scope the invention is defined in the claims, and may include other examples that occur to those skilled in the art. Such other examples are intended to be within the scope of the claims if they have structural elements that do not differ from the literal language of the claims, or if they include equivalent structural elements within substantial differences from the literal languages of the claims.

1. An application and method for placing an Internet audio or video call using a ping tag, which is a quick response (QR) code image mapping to a call service with a mobile device, wherein the said call service is provided by a cloud platform configured for establishing said call between a caller's and a callee's mobile device. The method and application further comprising of:
I. a backend database system configured to store a user database and a call service database; wherein: the user database further containing a user profile table storing user logon, authentication data, phone number, email address together with statistics, analytics and control data; and the call service database further containing at least a ping tag table for storing said ping tags, each further comprising owner's user id, tag type, corresponding tag profile data, alternate contact data, call option settings and a list of call recipients; a call session table for storing call session management information between the caller and one or more call recipients and a blacklist table for storing a list of callers being blacklisted from placing calls against one or more said ping tag; wherein the said call options further comprising a call mode and a call routing mode settings.
II. a user management module coupled with the said backend database system over a computer network and configured to register and store user profile information in a user database, authenticate users for service as well as allowing an administrator to perform administrative user management tasks;
III. a call server coupled with the said backend database system over a computer network and configured to store and access call session data, said ping tag data and block caller data in the call service database for establishing call session between a caller and a callee; the said method further comprising of the steps:
A. generating a QR code image corresponding to a said ping tag stored on the said platform in the form of a service API (URL) and posting the said image on the surface of an object for scanning;
B. scanning the said QR code image using the backend camera of a mobile device to retrieve the said service API associated with the said ping tag;
C. using the said service API for accessing the said call service system in order to place a call to one or more call recipients of the said ping tag using the call options configured for the said ping tag.

2. An application and method for placing an Internet audio or video call as in claim (1) which further comprises a series of steps for transmitting a live video stream of the caller using the front camera of caller's mobile device to one or more call recipient's mobile device for inspection by call recipient prior to accepting or rejecting the said call.

3. An application and method for placing an Internet audio or video call as in claim (1) wherein said method and application can further allow a call recipient to block future call from the said caller using the said QR code image by recording the caller's user id to the said black-list table of the said call service database.

4. An application and method for placing an Internet audio or video call as in claim (1) which further allows the said caller to leave a text, voice or video message to the said call recipient(s) if the call has not been answered.

5. An application and method for placing an Internet audio or video call as in claim (1) which further allows the said caller to reach out to the said call recipient using one of said alternate contacts configured in the said ping tag.

6. An application and method for placing an Internet audio or video call as in claim (1) that further allows multiple callers to place said call from the said ping tag at the same time with each said call to be established with a said call recipient in the said call recipient list.

7. An application and method for placing an Internet audio or video call as in claim (1) that further allows a user to claim a ping tag that has not been associated with any users, the said claim process further comprising of the following steps:
a. generating a said QR code image corresponding to the said ping tag;
b. scanning the said QR code image for retrieving the said ping tag id;
c. retrieving the said ping tag from the said call service system;
d. configuring the said ping tag; and
e. updating the said ping tag with the said configured data in association with the said user.

8. An application and method for placing an Internet audio or video call as in claim (1) wherein the said user database further comprises of a group table for registering and storing business profile of one or more business, each identified by a group ID and the said call service system further providing support for routing incoming calls initiated from a QR code image associated with the said group id, to devices of individual members of the said business by group ID and extension.

9. An application and method for placing an Internet audio or video call as in in claim (8) which further allows a user to claim an access code (or extension) of a business ping tag and further comprising of the following steps:
a. scanning the QR code image associated with the said business ping tag for the said group id;
b. entering the said access code;
c. creating a new ping tag with the group ID set to said group ID and access code set to access code;
d. setting up tag profile, alternate contacts, call options and call recipient list for the said unclaimed ping tag; and
e. storing the said ping tag on the said call service system.

10. An application and method for placing an Internet audio or video call as in claim (1) for placing an Internet audio or video call using a ping tag, which is a quick response (QR) code image mapping to a call service, to a mobile device, using the methods in claims (1) to (7). Said system and method comprises a cloud platform as described in claim (1) and a mobile app; wherein the said mobile app to be installed on end-user's mobile device and the said end-user further using the said mobile app to: register for call service provided by the said platform; set up or claim a said ping tag for receiving incoming calls from the said ping tag; generate a QR code image corresponding to a ping tag setup; expose the said QR code image in visible places or share online for scanning and placing call by other mobile users; receive incoming calls initiated by scanning the said QR code image; interact with the said mobile app to accept or reject incoming calls and other call-related operations.

11. An application and method for placing an Internet audio or video call as in claim (1) wherein said method and system in claim (10) allows placing call using quick response (QR) code to members of a business, which is registered for call service with the said system, by extension and receiving call set forth, using the methods in claims (8) to (9). The system further comprises of: a cloud platform as described in claim (8) and a mobile app. Wherein said mobile app is installed on end-user's mobile device and the said end-user further uses the said mobile app to: register for call service provided by the said platform, claim an extension of the said business account for receiving incoming calls, receive incoming calls, interact with the said mobile app to accept and reject incoming calls, block undesirable callers, engage in video call conversation with caller, place a callback or to receive, view and or play multi-media messages from callers.

12. An application and method for placing an Internet audio or video call as in claim (11) wherein the said end-user further generates a QR code image from the said claimed ping tag for personal use using the said mobile app on own device.

13. An application and method for placing an Internet audio or video call as in claim (11) further comprising of: a smart doorbell device for displaying a quick response (QR) code for scanning. Said device further comprising of: a ring button; a small graphical display for displaying a QR code which is an encoded representation of a call service offered by the call service unit accessible via a web resource link (URL); a Bluetooth module configured to provide a communication channel between a processor which resides inside the doorbell within a mobile device running the app of the present invention; a radio unit used to send radio signal to an indoor device for ringing the bell when the ring button is pressed on and a flash storage capable of storing executable program instruction and said QR code image.

14. An application and method for placing an Internet audio or video call as in claim (13) wherein the said smart doorbell device further comprising of: a protocol allowing the user to upload said QR code image from a mobile device using the said Bluetooth module for storing in the said flash module and displaying on the display unit of the said doorbell system; thus, making the said code visible for scanning by a mobile device camera.

15. An application and method for placing an Internet audio or video call as in claim (13) wherein the said smart doorbell device further allows the user to replace the said QR code image stored in the said flash memory with another QR code image and to refresh the display for displaying the replacing QR code image.

16. An application and method for placing an Internet audio or video call as in in claim (1) to claim (9) for establishing a contact point for one or more check-in baggage with a passenger of an airline, which further comprising of the following steps:
A. issuing a said ping tag for attaching to said baggage;
B. issuing a baggage claim ticket with a QR code in association with the said QR code attached to one or more said baggage;
C. scanning the said QR code on the said claim ticket to set up point of contact for the said baggage using the said method in claim 7.b) to 7.e).
